(19) United States
(12) Patent Application Publication
(10) Pub. No.: US 2008/0010024 A1
(43) Pub. Date: Jan. 10, 2008

(54) Cellular fibronectin as a diagnostic marker in cardiovascular disease and methods of use thereof

(75) Inventor: Cornelius Diamond, Leucadia, CA (US)

Correspondence Address: William C. Fuess, Suite 2G, 10951 Sorrento Valley Road, San Diego, CA, 92121-1613, US

(73) Assignee: Prediction Sciences LLP

(21) Appl. No.: 11/890,134

(22) Filed: Aug. 2, 2007

Related U.S. Application Data
(63) Continuation-in-part of application No. 11/346,862, filed on Feb. 1, 2006.
Application No. 11/346,862 is a continuation-in-part of application No. 11/046,592, filed on Jan. 29, 2005, now abandoned.
Application No. 11/046,592 is a continuation-in-part of application No. 10/948,834, filed on Sep. 22, 2004, now abandoned.
(60) Provisional application No. 60/505,606, filed on Sep. 23, 2003.
(60) Provisional application No. 60/556,411, filed on Mar. 24, 2004.

(51) Int. Cl. G06F 19/00

(52) U.S. Cl. 702/19

(57) ABSTRACT

Thrombolytic therapy in the treatment of a cardiovascular event such as myocardial infarction (MI) carries with it a chance of suffering a hemorrhagic incident leading to severe disability and often death. Methods for the evaluation of proper therapy for a specific patient who has suffered a cardiovascular event employ a variety of bio-markers including cellular fibronectin (c-Fn) assembled as a panel for evaluation. Methods are disclosed for selecting markers and correlating their combined levels with a clinical outcome of interest. In various aspects the methods permit early detection of potential bleeding events, determination of the prognosis of a patient presenting cardiovascular damage, and identification of a patient at risk for hemorrhage when given thrombolytic therapy. The disclosed methods provide rapid, sensitive and specific assays to greatly reduce the risk of bleeding or the number of patients that can receive the most beneficial treatment for their cardiovascular event, and to reduce the human and economic costs associated with bleeding following such treatments.

### REFERENCE TO RELATED APPLICATIONS

The present application is a continuation-in-part of U.S. utility patent application Ser. No. 11/346,862, which is a continuation-in-part of U.S. utility patent application Ser. No. 11/046,592, which is a continuation-in-part of U.S. utility patent application Ser. No. 10/948,834, which application is itself descended from U.S. provisional patent applications 60/505,606 and 60/556,411, the contents of all of which are hereby incorporated herein in their entirety, including all tables, figures, and claims.

### BACKGROUND OF THE INVENTION

1. Field of the Invention

The present invention generally relates to the identification and use of diagnostic markers for vascular damage leading to bleeding events in cardiovascular disease, particularity myocardial infarction (MI). In a various aspects, the present invention particularly relates to methods for (1) the prediction of a bleeding event in cardiac patients prior to surgery; (2) the prediction of intracerebral hemorrhage (ICH) in cardiac patients who are given a thrombolytic; (3) for the identification of patients who would not have an elevated bleeding risk when given a combination antiplatelet/thienopyridine derivative therapy such as aspirin or dipyridamole, and clopidogrel or ticlopidine, and (4) the identification of patients who could benefit from cardiac artery stenting or balloon angioplasty.

2. Background of the Invention

The following discussion of the background of the invention is merely provided to aid the reader in understanding the invention and is not admitted to describe or constitute prior art to the present invention.

In recent years, thrombolytic therapy with fibrinolytic (thrombolytic) agents has revolutionized the treatment of diverse circulatory disorders such as pulmonary embolism, deep-vein thrombosis and myocardial infarction [see for instance Collen D, Stump D C, Gold H K (1988) Thrombolytic therapy. Annu Rev Med 39:405-423]. These circulatory disorders are increasingly becoming the leading causes of mortality in modern societies worldwide. Thrombolytic agents have the unique ability to activate the components intrinsic to the fibrinolytic system, resulting in the degradation of blood clots, which restores blood flow through the occluded vessels [see for instance Collen D, Lijnen J R (1986) The fibrinolytic system in man. Crit Rev Hemat Oncol 4:249-301].

The fibrinolytic agents commonly used in thrombolytic therapy are streptokinase (SK), urokinase (UK) and derivatives of tissue type plasminogen activator (tPA or Alteplase) such as Reteplase, Tenecteplase, and Lanoteplase. These agents are commonly referred to as plasminogen activators, since their mode of action is through the conversion of the enzymatically inert plasminogen (PG) of the fibrinolytic system to an active protease, plasmin (PN), that dissolves the fibrin clots and solubilises degradation products, which can be removed by the phagocytes.

This helps to restore blood flow through the occluded vessel. Unlike UK and tPA, which themselves proteases, SK possesses no enzymatic activity of its own. Rather, it acquires the highly specific PG activating property indirectly, by first forming a high-affinity 1:1 stoichiometric complex with PG or PN. The resultant activator complex is a highly specific protease, which converts other PG molecules to proteolytically active PN through a series of biochemically distinct steps [see Castellino F J (1981) Recent advances in the chemistry of the fibrinolytic system. Chem Rev 81:431-446].

The choice of a thrombolytic agent during therapy is dictated by a number of factors, which depends essentially upon the relative merits and demerits of individual PG activators. These include the cost of the drug, the side-effects and their severity such as major bleeding and Intercerebral hemorrhage (ICH), in vivo stability and specificity towards fibrin clots and immunological reactivity.

In patients with myocardial infarction, balloon angioplasty reduces short-term death, nonfatal myocardial infarction, and stroke when compared with thrombolytic reperfusion [see for instance E. C. Keeley, J. A. Boura and C. L. Grines, Primary angioplasty versus intravenous thrombolytic therapy for acute myocardial infarction: a quantitative review of 23 randomised trials. Lancet 361 (2003), pp. 13-20.]. Still, the clinical efficacy of balloon angioplasty is limited by the development of late restenosis in up to 50% of patients, and by recurrent myocardial infarction in 3% to 5% of patients [see for instance C. M. Nunn, W. W. O'Neill, D. Rothbaum et al., Long-term outcome after primary angioplasty: report from the Primary Angioplasty In Myocardial Infarction (PAMI-I) trial. J Am Coll Cardiol 33 (1999), pp. 640-646.]. However, the alternative, stenting, has a higher rate of postinterventional bleeding complications, defined as retroperitoneal, intracerebral, or fatal bleedings with the need for vascular repair or blood transfusion.

Recent trials have confirmed the importance of achieving early, complete, and sustained reperfusion after acute myocardial infarction (see for instance The GUSTO Investigators. An international randomized trial comparing four thrombolytic strategies for acute myocardial infarction. N Engl J Med 1993; 329:673-682.). In the Global Utilization of Streptokinase and Tissue Plasminogen Activator for Occluded Coronary Arteries (GUSTO I) trial, an accelerated infusion of alteplase led to a relative reduction in 30-day mortality of 14.6 percent as compared with streptokinase, the previous standard therapy. The reason for the enhanced survival with tissue plasminogen activator (alteplase) proved to be a higher rate of complete patency of the infarcted vessel 90 minutes after therapy, as determined angiographically, but this was achieved in only 54 percent of patients (see for instance Lincoff A M, Topol E J. Illusion of reperfusion: does anyone achieve optimal reperfusion during acute myocardial infarction? Circulation 1993; 88:1361-1374.). Accordingly, a major goal of myocardial reperfusion therapy is to improve this rate of early fibrinolysis.

Reteplase (recombinant plasminogen activator, r-PA) is a single chain deletion mutant of alteplase that is expressed in Escherichia coli and, therefore, is expressed as an unglycosylated protein. Reteplase includes 355 amino acids with a total molecular weight of 39 kDa. The molecule consists of cringle 2 and the protease domain of the alteplase molecule. Because of the deletion of the fibronectin finger region, the binding of reteplase to fibrin is significantly reduced in comparison with that of alteplase. Although kringle 2 (known to stimulate protease in the presence of fibrin) is part of the reteplase molecule, reteplase is stimulated in the presence of fibrin to a lower extent than alteplase, suggesting that the fibronectin finger is involved in the stimulation of the protease as well. Reteplase, in comparison with alteplase, is characterised by reduced fibrin selectivity. In the absence of fibrin, reteplase and alteplase do not differ with respect to their activity as plasminogen activators, nor do they differ with respect to their inhibition by the plasminogen activator inhibitor type 1 (PAI-1). (see for instance Martin U, Bader R, Böhm E, et al. BM 06.022: a novel recombinant plasminogen activator. Cardiovasc Drugs Rev 1993; 11:299-311.). The elimination of reteplase from the circulating plasma predominantly occurs in the liver. Because of the deletion of the fibronectin finger region, the epidermal growth factor domain and kringle 1, as well as the carbohydrate side chains, the hepatic elimination of the molecule is reduced. Consequently, plasma half life is increased to 14-18 minutes (versus 3-4 minutes with alteplase). This allows reteplase to be administered as boli (versus as an initial bolus followed by an infusion, as with alteplase). Since early reocclusions of the infarct related coronary artery had been observed with the single bolus administration, it was replaced by a double bolus one. The best results have been obtained with a double bolus of 10 U each 30 minutes apart in the case of an acute myocardial infarction. In two angiographic trials, reteplase compared favorably with alteplase with regard to enhanced patency of the infarct-related vessel and the incidence of bleeding complications (see for instance Bode C, Smalling R W, Berg G, et al. Randomized comparison of coronary thrombolysis achieved with double-bolus reteplase (recombinant plasminogen activator) and front-loaded, accelerated alteplase (recombinant tissue plasminogen activator) in patients with acute myocardial infarction. Circulation 1996; 94:891-898.). In summary, reteplase in comparison with alteplase is equal in efficacy and superior in its application as a double bolus that also facilitates prehospital initiation of reperfusion therapy.

Tenecteplase is also called the TNK-mutant of alteplase. The molecule does not constitute a deletion mutant of alteplase (as reteplase does). Instead, it consists of the alteplase molecule with the exception of three point mutations. At position 103 of the polypeptide the aminoacid threonine has been replaced by asparagine leading to a new glycosylation site. The carbohydrate chain that is linked to this site enlarges the molecule, thereby reducing its elimination and prolonging its plasma half life. At position 117 asparagine has been replaced by glutamine. By the exchange of this amino acid the carbohydrate side chain that facilitates hepatic elimination has been removed. Hence, plasma half life is further prolonged. Finally, at position 296-299 the amino acids lysine, histidine, arginine, and arginine have been replaced by four amino acids alanine. Consequently, the inhibition by PAI-1 is reduced 80 times in comparison with alteplase. The amino acids that were replaced at the three positions are called T, N, and K according to the one letter code for amino acids, which leads to the expression TNK-mutant. Since the molecule is expressed in Chinese hamster ovary cells, it is expressed with carbohydrate side chains linked to the glycosylation sites of the polypeptide. The relatively long-plasma half life of tenecteplase (approximately 17 minutes) allows for single bolus application in the thrombolytic treatment of acute myocardial infarction. Compared with the alteplase molecule, no domain is missing in the tenecteplase molecule, so its fibrin selectivity is relatively high.

Tenecteplase has been tested extensively in clinical trials. In the ASSENT-1 (assessment of safety and efficacy of a new thrombolytic agent) trial in patients with acute myocardial infarction (see for instance van de Werf F et al. Safety assessment of single-bolus administration of TNK tissue-plasminogen activator in acute myocardial infarction: the ASSENT-1 trial. Am Heart J 1999; 137:786-91.), single bolus tenecteplase proved to be as safe as the gold standard of thrombolytic therapy, the accelerated regimen of alteplase (initial bolus followed by an infusion over 90 minutes). With respect to intracranial bleeding complications the rate in patients treated within six hours of the onset of myocardial infarction was 0.56% with 30 mg tenecteplase and 0.58% with 40 mg tenecteplase. In the TIMI-10B (thrombolysis in myocardial infarction) trial single bolus administration of 40 mg tenecteplase achieved the same rate of patency at 90 minutes after the initiation of thrombolytic therapy as alteplase in the accelerated regimen did (see for instance Cannon C P et al. TNK-tissue plasminogen activator compared with front-loaded alteplase in acute myocardial infarction: results of the TIMI 10B trial. Circulation 1998; 98:2805-14.). In the ASSENT-2 trial tenecteplase and alteplase were equal with respect to total mortality after 30 days (see ASSENT-2 Investigators. Single-bolus tenecteplase compared with front-loaded alteplase in acute myocardial infarction: the ASSENT-2 double-blind randomised trial. Lancet 1999; 354:716-22.). As with reteplase, tenecteplase in comparison with alteplase is equal in efficacy and superior in its application as a single bolus that also facilitates prehospital initiation of reperfusion therapy. However, in ASSENT-2, the ICH rate increased to 0.94% and 0.93% for alteplase and tenecteplase, respectively, with over 8460 patients studied in each arm.

The plasminogen activator lanoteplase (novel plasminogen activator, n-PA) is another deletions mutant of the alteplase molecule that also exhibits an additional, single point mutation. In comparison with alteplase the fibronectin finger region and the epidermal growth factor domain have been deleted in the lanoteplase molecule. In addition, in kringle 1, at position 117 the aminoacid asparagine has been replaced by glutamine. Because of this point mutation the glycosylation site that is responsible for facilitated hepatic elimination is lost. Consequently, the plasma half life of lanoteplase is increased. All other carbohydrate side chains are incorporated because lanoteplase is expressed in CHO cells, just as is tenecteplase. CHO cells are eukaryotic cells, in contrast to prokaryotic cells such as E coli. The plasma half life of lanoteplase is about 10 times that of alteplase and may reach 45 minutes. In the thrombolytic treatment of an acute myocardial infarction lanoteplase can be administered as a single bolus. This molecule is described further in U.S. Pat. No. 6,882,051 filed Jul. 3, 1986, incorporated by reference.

In the InTIME-1 (intravenous n-PA for treatment of infarcting myocardium early) trial, treatment with 120 kU lanoteplase per kg body weight resulted in a higher patency rate of the infarct related coronary artery at 90 minutes than treatment using alteplase in the accelerated regimen (see den Heijer P, et al. Evaluation of a weight-adjusted single-bolus plasminogen activator in patients with myocardial infarction: a double blind, randomized angiographic trial of lanoteplase versus alteplase. Circulation 1998; 98:2117-25.). However, with respect to overall mortality at 30 days lanoteplase and alteplase were equally effective (InTIME-2 trial). The latter trial also demonstrated an increased rate of haemorrhagic stroke with lanoteplase (1.12%) than with alteplase (0.64%, p=0.004). This increase in the most severe complication of thrombolytic therapy has stopped lanoteplase from entering the market to date.

In the field of reperfusion therapy in acute myocardial infarction, the term “combination therapy” is most often used to describe the combined use of reduced dose plasminogen activators and full dose glycoprotein (Gp) IIb/IIIa inhibitors. The latter block the Gp IIb/IIIa receptors at the surface of activated platelets and, subsequently, platelet aggregation, the major mechanism in reocclusion (see for instance Nordt T K, Moser M, Kohler B, et al. Augmented platelet aggregation as predictor of reocclusion after thrombolysis in acute myocardial infarction. Thromb Haemost 1998; 80:881-6.). Since the activated receptor constitutes the final common pathway of platelet activation, the Gp IIb/IIIa inhibitors form the most potent antiplatelet therapy now available. Among them abciximab, eptifibatide, and tirofiban have proven their clinical efficacy.

In the TIMI 14 trial alteplase at half dose (15 mg as an initial bolus, 35 mg as an infusion over 60 minutes) combined with abciximab at full dose (0.25 mg/kg as an initial bolus, 10 μg/min as an infusion over 12 hours) yielded the highest patency rate 90 minutes after the initiation of treatment (TIMI 3 flow in 76% of treated patients) without increasing the risk of severe bleeding complications (see Antman E M et al. Abciximab facilitates the rate and extent of thrombolysis. Results of the TIMI 14 trial. Circulation 1999; 99:2710-32.). Additional analysis of the trial showed that microvascular reperfusion (quantified by resolution of ST segment elevation) was re-established more often with the combination therapy than with alteplase treatment alone (see de Lemos J A, Antman E M, Gibson C M, et al. Abciximab improves both epicardial flow and myocardial reperfusion in ST-elevation myocardial infarction. Observations from the TIMI 14 trial. Circulation 2000; 101:239-43.). In the SPEED (strategies for patency enhancement in the emergency department) trial a patent coronary artery could be achieved more often with the combination of reteplase in half dose (a double bolus of 5 U each, 30 minutes apart) and abciximab in full dose than with reteplase in full dose alone (see SPEED Group. Trial of abciximab with and without low-dose reteplase for acute myocardial infarction. Circulation 2000; 101:2788-94.). However, in the GUSTO V trial the higher patency rate of this regimen could not be translated into reduced mortality after 30 days (see GUSTO V Investigators. Reperfusion therapy for acute myocardial infarction with fibrinolytic therapy or combination reduced fibrinolytic therapy and platelet glycoprotein IIb/IIIa inhibition: the GUSTO V randomised trial. Lancet 2001; 357:1905-14.). In the ASSENT 3 trial half dose tenecteplase combined with abciximab was compared with full dose tenecteplase alone (see ASSENT-3 Investigators. Efficacy and safety of tenecteplase in combination with enoxaparin, abciximab, or unfractionated heparin: the ASSENT-3 randomised trial in acute myocardial infarction. Lancet 2001; 358:605-13.). With respect to the primary end point (a composite end point combining 30 day mortality, in-hospital reinfarction, or in-hospital refractory ischaemia), the combination therapy was superior to monotherapy with plasminogen activator but without Gp IIb/IIIa inhibitor.

Thus large clinical trials of thrombolytic therapy have shown impressive reductions in mortality associated with the use of thrombolytic agents in the setting of acute myocardial infarction. They have also consistently shown that thrombolysis imposes an excess risk for intracranial hemorrhage. Although the incidence of intracranial hemorrhage associated with thrombolytic therapy is low compared to its usage in ischemic stroke, this complication is characterized by high fatality rates and substantial disability among survivors. In the Global Utilization of Streptokinase and Tissue Plasminogen Activator (tPA) for Occluded Coronary Arteries (GUSTO-I) trial, intracranial hemorrhage rates were 0.46%, 0.57%, 0.70%, and 0.88% among patients treated with streptokinase plus subcutaneous heparin, streptokinase plus intravenous heparin, accelerated tPA, and combination therapy, respectively. Sixty percent of patients who had intracranial hemorrhage died, and another 25% were disabled.

The underuse of thrombolysis in special patient populations, such as elderly persons, is usually attributed to concerns about the risk for bleeding, particularly intracranial hemorrhage (see for instance Krumholz H M et al., Thrombolytic therapy for eligible elderly patients with acute myocardial infarction. JAMA. 1997; 277:1683-8.). These concerns often dominate decisions about the use of thrombolytic agents in eligible elderly patients with acute myocardial infarction despite the potential for substantial survival benefits from treatment. In the GUSTO-I trial, 0.42% of patients younger than 75 years of age treated with streptokinase and 0.52% of those treated with accelerated tPA experienced a hemorrhagic stroke by 30 days of follow-up. Among patients older than 75 years of age, these values were 1.23% and 2.08%, respectively. Simoons and colleagues (see Simoons M L et al. Individual risk assessment for intracranial haemorrhage during thrombolytic therapy. Lancet. 1993; 342:1523-8.) combined information from a national registry of thrombolytic therapy with data from multiple thrombolytic trials to identify 150 patients who had had intracranial hemorrhage and compared them with 294 patients with acute myocardial infarction who received thrombolytic therapy but did not experience this outcome. After adjustment for other factors, including type of thrombolytic agent, body weight, and presence of hypertension on admission, patients older than 65 years of age were significantly more likely to experience intracranial hemorrhage (odds ratio, 2.2 [95% Cl, 1.4 to 3.5]). Further illustrating this fact is the study by Soumerai and collegues (see Soumerai et al. Effectiveness of Thrombolytic Therapy for Acute Myocardial Infarction in the Elderly Cause for Concern in the Old-Old) Overall, in this study, 0.6% of study patients experienced a fatal or nonfatal hemorrhagic stroke; among younger thrombolytic recipients (age, <75 years), this rate was 1.4% compared with 0.2% among nonrecipients (p=0.02); among patients 75 years and older, hemorrhagic stroke occurred in 2.4% of thrombolytic recipients compared with 0.2% of nonrecipients (p<0.001).

Major bleeds, defined as retroperitoneal, intracerebral, or fatal bleedings with the need for vascular repair or blood transfusion, are also a major problem in the administration of thrombolytic therapy. In the ASSENT-II trial, major bleeds occurred at a rate of 5.9% for accelerated infusion of alteplase and 4.65% for tenecteplase in cardiac patients given a thrombolytic.

Accordingly, there is a present need in the art for a rapid, sensitive and specific differential diagnostic assay to identify patients who are likely to experience an ICH or major bleed event when given a thrombolytic therapy, or to identify patients who are likely to benefit from combination therapy, or to identify patients who could benefit from cardiac artery stenting or balloon angioplasty. Such a diagnostic assay would greatly increase the number of patients that can receive beneficial MI treatment and in so doing reduce the mortality and costs associated with incorrect MI therapy.

### BRIEF SUMMARY OF THE INVENTION

The present invention relates to the identification and use of diagnostic markers for the detection of bleed events in cardiovascular disease. The methods and compositions described herein can meet a need in the healing arts for rapid, sensitive and specific diagnostic assay to be used in the diagnosis and differentiation of various bleeding events. Moreover, the methods and compositions of the present invention can also be used to facilitate the treatment of MI patients and the development of additional diagnostic and/or prognostic indicators.

In various aspects, the present invention relates to (1) materials and procedures for identifying markers that are associated with the diagnosis, prognosis, or differentiation of patients at risk of a major bleeding event or ICH following a cardiovascular event such as MI; (2) using such markers in diagnosing and treating a patient with cardiovascular disease and/or monitoring the course of a treatment regimen; (3) using such markers to identify subjects at risk for one or more adverse outcomes related to MI and/or may benefit from a therapy that would not normally be given to patients due to extra-ordinary risk of a major bleed event or ICH by providing a prediction as to bleed or ICH risk for the individual patient, said patient who is predicted to have a greatly lessened risk of a major bleed event or ICH when given said therapy is able to use said therapy; and (4) using at one of such markers an outcome marker for screening compounds and pharmaceutical compositions that might provide a benefit in treating or preventing such conditions.

In one of its aspects, the invention discloses methods for determining a prediction of a bleeding event such as ICH in patients suffering from cardiovascular disease. The preferred method includes analyzing a fluid sample obtained from a person who has an unknown risk for the levels of one or more markers specific to the damage caused by said cardiovascular disease. In the case of MI, these markers would be drawn from the group consisting of markers relating to vascular damage, glial activation, inflammatory mediation, thrombosis, cellular injury, apoptosis, myelin breakdown, and specific and non-specific markers of cardiovascular disease. The analysis of the preferred method thus more precisely includes identifying one or more markers the presence or amount of which is associated with the diagnosis, prognosis, or differentiation of cardiovascular events, prediction of major bleeding events or ICH, and/or efficacy of a therapeutic treatment for cardiovascular disease. Once such marker(s) are identified, the level of such marker(s) in a sample obtained from a subject of interest can be measured. In certain embodiments of the preferred method, these markers can be compared to a level that is associated with the diagnosis, prognosis, or differentiation of cardiovascular disease including prediction of bleeding or ICH risk or suitability of administration of a therapeutic such as lanoteplase to a patient. By correlating the subject's marker level(s) to the predictive diagnostic marker level(s), the presence or absence of cardiovascular disease condition, and also the probability of future adverse outcomes with a given therapeutic regime, etc., in a patient may be rapidly and accurately determined.

In another of its aspects, the instant invention is embodied in methods for choosing one or more marker(s) for prediction of bleeding and/or ICH risk in patients with cardiovascular disease, including determination of ICH risk before administering a specific therapy such as lanoteplase, that together, and as a group, have maximal sensitivity, specificity, and predictive power. Said maximal sensitivity, specificity, and predictive power is in particular realized by choosing one or more markers as constitute a group by process of plotting receiver operator characteristic (ROC) curves for (1) the sensitivity of a particular combination of markers versus (2) specificity for said combination at various cutoff threshold levels. In addition, the instant invention further discloses methods to interpolate the nonlinear correlative effects of one or more markers chosen by any methodology to such that the interaction between markers of said combination of one or more markers promotes maximal sensitivity, specificity, and predictive accuracy in the prediction of any of the occurrence of major bleed events, ICH, determination of thrombolytic usage, and/or prediction of bleeding risk in stenting and/or angioplasty.

The term “marker” as used herein refers to proteins or polypeptides to be used as targets for screening test samples obtained from subjects. “Proteins or polypeptides” used as markers in the present invention are contemplated to include any fragments thereof, in particular, immunologically detectable fragments. One of skill in the art would recognize that proteins which are released by cells of the central nervous system which become damaged during a cerebral attack could become degraded or cleaved into such fragments. Additionally, certain markers are synthesized in an inactive form, which may be subsequently activated, e.g., by proteolysis. Examples of such markers are described hereinafter. The term “related marker” as used herein refers to one or more fragments of a particular marker that may be detected as a surrogate for the marker itself. These related markers may be, for example, “pre,” “pro,” or “prepro” forms of markers, or the “pre,” “pro,” or “prepro” fragment removed to form the mature marker. Exemplary markers that are synthesized as pre, pro, and prepro forms are described hereinafter. In preferred embodiments, these “pre,” “pro,” or “prepro” forms or the removed “pre,” “pro,” or “prepro” fragments are used in an equivalent fashion to the mature markers in the methods described herein.

Preferred markers of the invention can aid in the determination of risk of a major bleeding event or ICH, and/or predicting subsequent enlargement of the hematoma after ICH. Preferred markers are drawn from the group including c-Fn, MMP-9, myelin basic protein, IL-1, IL-1rα, IL-1β, IL-6, IL-8, IL-10, NCAM, VCAM, ICAM, S100β, GFAP, BNGF, CRP, β-TG, PF-4, D-Dimer, TGF-α, NT-3, F₁₊₂, VEGF, CK-BB, caspase 3, MCP-1, total homocysteine (tHcy), thrombin-antithrombin III complex, tissue factor, GFAP, NSE-γγ, vWF, VEGF, FPA, serum amyloid A (SAA), and NR2A/2B. Each of these terms are defined hereinafter. Particularly preferred markers from this group are ones that have proven highly predictive of hemorrhagic events in the area of ischemic stroke: namely, cellular fibronectin (c-Fn) and matrix metalloprotein-9 (MMP-9).

Those of ordinary skill in the art know that marker levels vary at certain time points; for example, the level of a marker may be at one level at three hours post-cardiovascular event, and another level at nine hours post-cardiovascular event. Thus when using multiple markers together which may or may not be correlated with each other it is necessary to provide interpretation through an algorithm that relates all markers together. This algorithm in current state of the art is a simple threshold level above which a marker is said to be indicative of an adverse event in the human body. A particular diagnosis and/or prognosis of said adverse event may depend upon the comparison of each marker to this value; alternatively, if only a subset of markers are outside of a normal range, then this subset may be indicative of a said adverse event.

Thus, in certain embodiments of the methods of the present invention, a plurality of markers are combined using an algorithm to increase the predictive value of the analysis in comparison to that obtained from the markers taken individually or in smaller groups. Most preferably, one or more markers for vascular damage, glial activation, inflammatory mediation, thrombosis, cellular injury, apoptosis, myelin breakdown, and specific and non-specific markers of cardiovascular disease are combined in a single assay to enhance the predictive value of the described methods. This assay is usefully predictive of multiple outcomes, for instance: determining whether or not a hemorrhagic event occurred, determining the suitability of a certain, then further predicting stroke prognosis. Moreover, different marker combinations in the assay may be used for different indications. Correspondingly, different algorithms interpret the marker levels as indicated on the same assay for different indications.

Preferred panels comprise markers for the following purposes in patients suffering from cardiovascular disease: (1) prediction of ICH risk; (2) prediction of major bleed events; (3) prediction of bleeding risk from thrombolytic use, particularity lanoteplase; (4) diagnosis of cardiovascular disease and indication if a hemorrhagic or bleeding event has occurred; and (5) determination of whether stenting or angioplasty is preferable in light of risk of a bleeding complication.

In preferred embodiments, particular thresholds for one or more markers in a panel are not relied upon to determine if a profile of marker levels obtained from a subject are indicative of a particular diagnosis/prognosis. Rather, in accordance with the present invention, an evaluation of the entire profile is made by (1) first training an algorithm with marker information from samples from a test population and a disease population to which the clinical outcome of interest has occurred to determine weighting factors for each marker, and (2) then evaluating that result on a previously unseen population. Certain persons skilled in bioinformatics will recognize this procedure to be tantamount to the construction, and to the training, of a machine learning algorithm such as a kernal partial least squares algorithm. The evaluation is determined by maximizing the numerical area under the ROC curve for the sensitivity of a particular panel of markers versus specificity for said panel at various individual marker levels. From this number, the skilled artisan can then predict a probability that a subject's current marker levels in said combination is indicative of the clinical marker of interest. For example, (1) the test population might consist solely of samples from a group of subjects who have had cardiovascular disease and no other comorbid disease conditions, while (2) the disease population might consist solely of samples from a group of subjects who have had a hemorrhagic event after treatment of a MI that said group of subjects had all experienced. A third, “normal” population might also be used to establish baseline levels of markers as well in a non-diseased population.

In preferred embodiments of the marker, and marker panel, selection methods of the present invention, the aforementioned weighting factors are multiplicative of marker levels in a nonlinear fashion. Each weighting factor is a function of other marker levels in the panel combination, and consists of terms that relate individual contributions, or independent and correlative, or dependent, terms. In the case of a marker having no interaction with other markers in regards to then clinical outcome of interest, then the specific value of the dependent terms would be zero.

In yet another of its aspects, the present invention is embodied in methods for determining a treatment regimen for use in a patient who has experienced a cardiovascular event, particularity MI. The methods preferably comprise determining a level of one or more diagnostic or predictive markers as described herein, and using the markers to determine a treatment course for a patient. For example, a prediction might include the likelihood of IHC after MI when administering a thrombolytic therapy such as lanoteplase. One or more treatment regimens that improve the patient's prognosis by reducing the increased disposition for an adverse outcome associated with the prognosis can then be used to treat the patient. Such methods preferably comprise comparing an amount of a marker predictive of a subsequent bleed event or ICH after MI, said marker selected from the group consisting of cellular fibronectin (c-Fn), and matrix metalloprotease-9 (MMP-9), in a test sample from a patient diagnosed with acute MI to a predictive level of said marker, wherein said patient is identified as being at risk for a subsequent bleed event or ICH after MI by a level of said marker equal to or greater than said predictive level.

In yet another of its aspects, the present invention is embodied in kits for determining the diagnosis or prognosis of a patient. These kits preferably comprise devices, software and reagents for measuring one or more marker levels in a patient sample, and instructions for performing the assay. Additionally, the kits contain a computer software program to be run on a computer or other means for converting marker level(s) to a prognosis. Such kits preferably contain sufficient reagents to perform one or more such determinations, and are standardized to run on an instrument used to analyze blood samples, such as Abbott Laboratories' AxSYM®, Roche Diagnostics' Cardiac Reader®, or Dade Behring's Stratus® CS Analyzer. The kits may be packaged with a corresponding therapeutic, such as lanoteplase, with the administration of the drug cleared if the test kit delivers a result that is below a pre-determined threshold that predicts a particular adverse event, such as ICH, when the patient is administered said therapeutic.

### DETAILED DESCRIPTION OF THE INVENTION

1. Definitions

The term “test sample” as used in this specification refers to a sample of bodily fluid obtained for the purpose of diagnosis, prognosis, or evaluation of a subject of interest, such as a patient. In certain embodiments, such a sample may be obtained for the purpose of determining the outcome of an ongoing condition or the effect of a treatment regimen on a condition. Preferred test samples include blood, serum, plasma, cerebrospinal fluid, urine and saliva. In addition, one of skill in the art would realize that some test samples would be more readily analyzed following a fractionation or purification procedure, for example, separation of whole blood into serum or plasma components.

The term “markers of glial activation” as used in this specification refers to markers that indicate glial cell function. Glia mediate neuroendocrine and neuroimmune functions and are also important in synaptic remodeling and the loss of synaptic connections that occur during aging. These functions are carried out by changes in glia, including changes in shape, interactions with neurons and other glia, and gene expression. The predominant change that occurs in glia during aging is glial activation, which can progress to reactive gliosis in response to neurodegeneration. Markers distinguish normal and reactive glia. During aging, astrocytes hypertrophy and exhibit signs of metabolic activation, and astrocytic processes surround neurons. Microglia also become activated and subsets of activated microglial increase in number and may enter the phagocytic or reactive stage. Yet glial cells are intimately involved in the biochemical metabolic and neurotrophic support of the function of neurons, and glial actions at the synapses are crucial to normal neuronal transmission. Glia take up excess glutamate (which can be neurotoxic) and produce neurotrophic factors which keep cells alive, as well as interacting with other systems in transmitter-like actions. Thus, a loss of normal glial function could have dramatic impacts on normal neuronal function. Such specific markers of glial activation include, but are not limited to, GFAP, S100B, Mac-1, TLR4, TGF-β1 and CD14.

The term “markers of vascular damage” as used in this specification refers to markers that indicate endothelial damage. When the endothelium is damaged or becomes dysfunctional, a cascade leading to atherogenesis is precipitated, initiating a cycle of injury, immunologic induction, and amplification. Dysfunctional endothelium leads to increased permeability to lipoproteins and up-regulation of leukocyte and endothelial adhesion molecules. In response to the presence of certain activating substances, including oxidized LDL, monocyte chemotactic protein 1, interleukin (IL)-8, and platelet-derived growth factor (PDGF), leukocytes migrate into the wall of the artery. Such specific markers of vascular damage include, but are not limited to, c-Fn, MMP-9, endothelin-1 (ET-1), von Willebrand factor (vWf), and soluble (S-) adhesion molecules E-selectin, intercellular adhesion molecule-1 (ICAM-1), vascular cell adhesion molecule-1 (VCAM-1), plasma indexes of endothelial damage/dysfunction and soluble thrombomodulin (sTM).

The term “markers of inflammatory mediation” as used in this specification refers to markers that indicate an inflammatory response to a cardiovascular event. Inflammatory responses are initiated and perpetuated by the interaction of immune cells with cells of the affected vessel wall. This is directed by a network of chemical messengers, which, in a state of vascular health, exist as balanced but opposing forces. These markers include various cytokines, proteases, adhesion molecules, and acute phase proteins as participants in the generation of vascular inflammation. Such specific markers of vascular damage include, but are not limited to, Cellular adhesion molecules such as Intracellular adhesion molecule-1, Vascular cellular adhesion molecule-1, NCAM and Selectins such as E-Selectin; Chemokines such as monocyte chemoattractant protein-1; Cytokines such as Interleukins 1, 1β, 1 receptor antagonist, 6, 8, 10, 18, transforming growth factor β, and Tumor necrosis factor-α; Proteases such as the matrix metalloproteinases MMP-9, MMP-3, and MMP-2; Accessory signaling markers such as CD40/CD40L; and acute phase proteins such as C-reactive protein, vascular endothelial growth factor, ceruloplasmin, fibrinogen, α1-acid glycoprotein, α1-antitrypsin, and haptoglobin.

The term “markers of thrombosis” as used in this specification refers to markers that indicate an coagulation event in ischaemic stroke. The blood clotting system is activated when blood vessels are damaged, exposing collagen, the major protein that connective tissue is made from. Platelets circulating in the blood adhere to exposed collagen on the cell wall of the blood vessel and secrete chemicals that start the clotting process as follows: Platelet aggregators cause platelets to clump together (aggregate). They also cause the blood vessels to contract (vasoconstrict), which reduces blood loss. Platelet aggregators include adenosine diphosphate (ADP), thromboxane A2, and serotonin (5-HT). Coagulants such as fibrin then bind the platelets together to form a permanent plug (clot) that seals the leak.

Fibrin is formed from fibrinogen in a complex series of reactions called the coagulation cascade. The enzymes that comprise the coagulation system are called coagulation factors, which are numbered in the order in which they were discovered. They include factor XII, factor XI, factor IX, factor X, factor VII, and factor V. The activation of the coagulation factors results in the formation of thrombin, which acts as a cofactor for the conversion of fibrinogen into fibrin. After the leak has been sealed with a blood clot, the body responds with another set of chemical messengers that oppose the actions of these chemicals. These include: Platelet aggregation inhibitors and vasodilators, such as nitric oxide and prostacyclin, which is also known as prostaglandin I2 (PGI2) Plasminogen activators that promote the breakdown of fibrin, such as tissue plasminogen activator (t-PA) Anticoagulants that inhibit enzymes in the coagulation cascade, such as antithrombin III (activated by heparin) and proteins C and S.

Such specific markers of thrombosis include, but are not limited to, von Willebrand factor, thrombin-antithrombin III complex, proteins C and S, tissue factor, fibrinopeptide A, plasmin-α-2-antiplasmin complex, prothrombin fragment 1+2, D-dimer, platelet factor 4, and β-thromboglobulin.

The term “marker of cellular injury and myelin breakdown” as used in this specification refers to markers associated with damage to the structural and functional molecules of the cell. Although any biologically important molecule in a cell can be the target of injury producing stress, four biochemical systems are particularly vulnerable: (1) the cell membrane, (2) energy metabolism, (3) protein synthesis, and (4) genes. Because many of the biochemical systems of the cell are inter-dependent, injury at one site typically leads to secondary injury to other cellular processes.

Myelin is the outer lipid rich (fatty) layer that covers nerves and nervous system pathways in the brain and spinal cord. The myelin sheath, a lipid-rich multilamellar membrane of relative stability, both insulates and enhances conduction in nerve axons. A notable feature of myelin-specific proteins, in particular myelin basic protein, is their susceptibility to proteolytic activity and their encephalitogenicity, which induces inflammatory demyelination in the CNS. The final common pathway of myelin breakdown in vivo is well documented and there is evidence that myelin disruption can be mediated directly by soluble (circulating) factors and for following receptor-driven phagocytosis by macrophages. However the exact mechanism(s) of demyelination in ischemic attack is still unresolved, both antigen-specific and—non-specific events having the potential to generate the myelinolytic process.

Cerebral injury leads to breakdown of the blood-brain barrier (BBB), exposing CNS antigens to the peripheral circulation and allowing the peripheral circulation access to the brain. The breakdown of the BBB leads to rapid acquisition of MBP-reactive T cell clones and Igs in stroke patients but does not lead to autoimmune encephalitis. The degradation of myelin basic protein (MBP) by proteinase yields encephalitogenic peptides and its loss has been found to cause structural alteration of the myelin sheath. This suggests that MBP degradation is an initial step in the breakdown of myelin in demyelinating diseases. A calcium-activated neutral proteinase (calpain), which degrades MBP, was found to increase in activity in MS tissue and cerebrospinal fluid (CSF), and its presence in myelin suggests that myelin may be autodigested in demyelinating disease. The source of increased proteinase activity has been indicated as macrophages, lymphocytes, and proliferative astrocytes (reactive cells). Increased proteinase activity is found in Schwann cells in Wallerian degeneration, and the presence of calpain in myelin-forming oligodendrocytes and Schwann cells suggests that these cells are likely sources of degradative enzymes.

Such specific markers of cellular injury and myelin breakdown include, but are not limited to, creatinine phosphokinase brain band, tissue factor, Proteolipid protein, RU Malendialdehyde, calpain, and myelin basic protein.

The term “marker of apoptosis or growth factors” as used in this specification refers to markers involved in neuronal cell death. Numerous studies in experimental models of ischemia have now reported that apoptosis contributes to neuronal death (reviewed by Chalmers-Redman et al Mechanisms of nerve cell death: apoptosis or necrosis after cerebral ischemia. In: Green A R, Cross A J, eds. Neuroprotective Agents and Cerebral Ischemia. San Diego, Calif.: Academic Press; 1997:1-25.). Apoptosis requires the activation of a “cell death” gene program, and many of the extracellular signals that regulate apoptosis have been identified. For example, interaction between the Fas/APO-1 molecule, a cell surface protein, with its ligand (Fas-L) leads to programmed cell death. Soluble (s) Fas/APO-1, a molecule lacking the transmembrane domain of Fas/APO-1, blocks apoptosis by inhibiting interaction between Fas/APO-1 and Fas-L on the cell surface (see for instance Cheng J et al., Protection from Fas-mediated apoptosis by a soluble form of the Fas molecule. Science. 1994; 263:1759-1762.). Fas expression has been detected on B and T cells and on neutrophils. It has been suggested that the Fas/Fas-L pathway is one of the major mechanisms for T-cell-mediated cytotoxicity. It has also been demonstrated by in situ hybridization that the expression of Fas/APO-1 was induced in murine brain after transient global cerebral ischemia. Another gene product, bcl-2, has been shown to suppress apoptosis and to protect primary neuronal cell cultures from apoptosis induced by nerve growth factor depletion.

Macrophages and T lymphocytes kill target cells by inducing apoptosis, one of the potential mechanisms whereby the inflammatory cells invading the infarcted brain area participate in neuronal cell death. Stroke patients displayed an intrathecal production of proinflammatory cytokines, such as interleukin (IL)-1β, IL-6, IL-8, and granulocyte-macrophage colony-stimulating factor (GM-CSF), and of the anti-inflammatory cytokine IL-10 within the first 24 hours after the onset of symptoms, supporting the notion of localized immune response to the acute brain lesion in humans. Some of these cytokines (eg, IL-1β and IL-8) stimulate influx of leukocytes to the infarcted brain, a prerequisite for Fas/APO-1- and bcl-2-mediated apoptosis. TNF-α, a powerful cytokine inducing apoptosis in the extraneural compartment of the body, has been demonstrated to protect rat hippocampal, septal, and cortical cells against metabolic-excitotoxic insults and to facilitate regeneration of injured axons. More importantly, TNF-α and -β protect neurons against amyloid β-protein-triggered toxicity.

Other evidence demonstrates that apoptosis involves the activation of caspases, a unique family of structurally related, highly conserved, aspartate-specific, cysteine proteases that are necessary to carry out the signal for apoptotic cell death. Two members of the caspase family, caspase-1 and caspase-3, are known to cleave the most abundant caspase target substrate, actin. The 45-kDa actin is cleaved by caspase activation between Asp11 and Asn12 and between Asp244 and Gly245 to produce N-terminal 32-kDa fragments and C-terminal 15-kDa fragments. A polyclonal antibody to the last 5 amino acids of the C-terminus of the 32-kDa fragment of actin generated by caspase cleavage of intact actin has been developed and named “fractin” for “fragment of actin.” Fractin labeling provides indirect evidence of caspase activation and demonstrates initiation of an apoptotic pathway, but does not rule out secondary necrosis. Other markers for apoptosis include biochemical evidence of oligointernucleosomal DNA fragmentation into approximately 180-bp multiples resulting from endonuclease activation that can be demonstrated with a typical “laddering” appearance on agarose gel electrophoresis. In addition, the terminal deoxynucleotidyl transferase-mediated dUTP-biotin nick end labeling (TUNEL) technique, which identifies 3′-OH ends of DNA-strand breaks, has been widely used as a marker of DNA damage or repair. However, the lack of specificity of TUNEL in detecting oligointernucleosomal DNA fragmentation precludes its use as a defining feature of apoptosis.

Such specific markers of apoptosis and growth factors include, but are not limited to, Brain natriuretic peptide, caspase 3, calbindin-D, heat shock protein 60 and 70, c-fos, c-jun, ubiquitin, and cytochrome C.

The term “specific marker of cardiovascular disease” as used in this specification refers to proteins or polypeptides that are associated with cardiovascular and heart tissue, and which can be correlated with a cardiovascular disease, but are not correlated with other types of disease. Such specific markers of cardiovascular disease include, but are not limited to, troponin I, troponin T, Heart-fatty acid-binding protein, CRP, D-Dimer, tHcy, SAA, microalbuminuria, aldosterone, PAI-1, myeloperoxidase, proteolipid protein, thrombomodulin, and lipoprotein-associated phospholipase A2 (Lp-PLA2).

The term “non-specific marker of cardiovascular disease” as used in this specification refers to proteins or polypeptides that are elevated in the event of cardiovascular disease, but may also be elevated due to non-cardiovascular events. Non-specific markers include, but are not limited to, ApoC-I and ApoC-II, A-type natriuretic peptide, B-type natriuretic peptide, C-type natriuretic peptide, adrenomedullin, β-thromboglobulin, C-reactive protein, Cardiac Troponin I and Troponin T, Creatine kinase MB, D-dimer, E-selectin, endothelin-1, endothelin-2, and endothelin-3, A-, F-, and H-Fatty acid binding protein, fibrinopeptide A, hemoglobin α₂, chain head activator, insulin-like growth factor-1, MMP-3, plasmin-α-2-antiplasmin complex, platelet factor 4,8-epi PGF sub(2α), PGI2, PGE2, prothrombin fragment 1+2, thrombin-antithrombin III complex, tissue factor, transforming growth factor β, and von Willebrand factor.

The term “diagnosis”, as used in this specification refers to predict the type of disease or condition from a set of marker values and/or patient symptoms. This is in contrast to disease prediction, which is to predict the occurrence of disease before it occurs, and the term “prognosis”, which is to predict disease progression at a future point in time from one or more indicator value(s) at a previous point in time.

The term “correlating,” as used in this specification refers to a process in which a set of examples of clinical inputs from subjects, such as marker levels, and their corresponding outputs, such as whether a subject suffered from a specific type of stroke, are related to each other. This relationship can be determined by comparing such examples to examples from a control and/or disease-free population at a later point in time, and selecting those indicators which can differentiate between the two disease states as a function of time alone or in combination at a certain probability level. The selection process is described herein. The selected markers, each at a certain level range which might be a simple threshold, are said to be correlative or associative with one of the disease states. Said correlated markers can be then be used for disease detection, diagnosis, prognosis and/or treatment outcome. Preferred methods of correlating markers is by performing marker selection by a feature selection algorithm and classification by mapping functions described herein. A preferred probability level is a 3% chance, 5% chance, a 7% chance, a 10% chance, a 15% chance, a 20% chance, a 25% chance, a 30% chance, a 35% chance, a 40% chance, a 45% chance, a 50% chance, a 55% chance, a 60% chance, a 65% chance, a 70% chance, a 75% chance, a 80% chance, a 85% chance, a 90% chance, a 95% chance, and a 100% chance. Each of these values of probability is plus or minus 2% or less. A preferred threshold level for markers of the present invention is about 25 pg/mL, about 50 pg/mL, about 60 pg/mL, about 75 pg/mL, about 100 pg/mL, about 150 pg/mL, about 200 pg/mL, about 300 pg/mL, about 400 pg/mL, about 500 pg/mL, about 600 pg/mL, about 750 pg/mL, about 1000 pg/mL, about 2500 pg/mL, about 0.15 μg/mL, about 2 μg/mL, about 3.5 μg/mL, about 5.5 μg/mL, and about 6 μg/mL. The term “about” in this context refers to +/−10%.

2. Detailed Description

In accordance with the present invention, there are provided methods and apparatus for the identification and use of a panel of markers for the prediction of bleeding risk and/or ICH after MI.

Fibronectins are adhesive dimeric glycoproteins that promote cell-cell and cell-matrix interactions (see for instance Hynes R O. Fibronectins. Sci Am. 1986; 254:42-51.). Plasma fibronectin (p-Fn) is primarily produced by hepatocytes, but plasma also contains small quantities of cellular fibronectin (c-Fn), which is mainly synthesized by endothelial cells (see for instance Peters J H, Sporn L A, Ginsberg M H, Wagner D D. Human endothelial cells synthesize, process, and secrete fibronectin molecules bearing an alternatively spliced type II homology (ED1). Blood. 1990; 75:1801-1808.). Because c-Fn is largely confined to the vascular endothelium, high plasma levels of this molecule might be indicative of endothelial damage. In fact, plasma c-Fn levels have been reported to be increased in patients with vascular injury secondary to vasculitis, sepsis, acute major trauma, and diabetes, (see for instance Peters J H, Maunder R J, Woolf A D, Cochrane G H, Ginsberg M H. Elevated plasma levels of ED1_ (“cellular”) fibronectin in patients with vascular injury. J Lab Clin Med. 1989; 113:586-597; Kanters S D, Banga J D, Algra A, Frijns R C, Beutler J J, Fijnheer R. Plasma levels of cellular fibronectin in diabetes. Diabetes Care. 2000; 24:323-327.). Since HT after cerebral ischemia seems to be the result of the continuous disappearance of basal membrane components (see for instance Hamann G F, Okada Y, del Zoppo G J. Hemorrhagic transformation and microvascular integrity during focal cerebral ischemia/reperfusion. J Cereb Blood Flow Metab. 1996; 16:1373-1378.), in the instant invention we show high levels of plasma c-Fn are associated with IHC after a cardiovascular event.

Cellular Fibronectin, or ED1+. is an adhesive glycoprotein, is a fibronectin synthesized in endothelial cells. It contains an extra Type III domain (ED1, or EDA/EIIIA), as a result of alternative mRNA splicing. It circulates in the blood in small quantities. Endothelial cells do not express the ED1 domain under normal circumstances, but the ED1 domain is included in fibronectin molecules in pathological conditions (see for instance Dubin D, Peters J H, Brown L F, Logan B, Kent K C, Berse B, Berven S, Cercek B, Sharifi B G, Pratt R E: Balloon catheterization induced arterial expression of embryonic fibronectins. Arterioscler Thromb Vasc Biol. 15:1958 1967, 1995.) Because ED1-fn is not stored in cellular granules, concentration increases indicate increased synthesis. Because c-Fn is largely confined to the vascular endothelium, high plasma Ivels of this molecule might be indicative of endothelial damage. Plasma c-Fn levels have been reported to be increased in patients with vascular injury secondary to vasculitis, sepsis, acute major trauma, diabetes, and patients with ischemic stroke (see for instance Peters et al. Elevated plasma levels of ED1+ ‘cellular fibronectin’ in patients with vascular injury J Lab Clin Med. 1989. 113:586-597). It has been reported to associate with the hemorrhagic transformation (see for instance Castellanos et al., Plasma Cellular-Fibronectin concentration predicts hemorrhagic transformation after thrombolytic therapy in acute ischemic stroke, Stroke 2004; 35:000-000).

As ICH has a 30-50% mortality rate, half of this coming from continued bleeding, identification of markers of such bleeds is also of critical importance to change treatment outcomes. The instant invention demonstrates that plasma c-Fn levels in patients experiencing a MI are significantly higher in patients in which ICH occurs following thrombolytic therapy and teaches that c-Fn levels >6 μg/mL can predict the development of IHC with a sensitivity and negative predictive value of 100%. Therefore, c-Fn is a useful marker of those patients who are at greatest risk for ICH after MI.

The loss of microvascular integrity secondary to the continuous disappearance of the antigens of the endothelial components has been reported as being responsible for hemorrhagic transformation after ischemic injury (Castellanos et a/2004). Among these antigens, c-Fn is especially important because it mediates the interaction between the endothelium and blood cells as well as other blood components. Moreover, Fn plays an important role in blood clot formation by mediating the adhesion of platelets to fibrin (see for instance Hynes R O. Fibronectins. Sci Am. 1986; 254:42-51.), so the disappearance of the c-Fn of the vascular endothelium secondary to ischemia might damage this clotting mechanism, facilitating additional bleeding events. Although high c-Fn levels have been previously reported in patients with ischemic stroke, no previous data are available on the association between c-Fn levels in patients with acute ischemic stroke.

The increase of vascular permeability and subsequent extravasation of serum components leading to ICH after MI may be the result of several mechanisms including the activation of MMPs, which is secondary to ischemia. The instant invention also details the significant association between MMP-9 levels and ICH after MI and in a nonselected series of stroke patients who experience ICH. However, the fact that c-Fn is almost exclusively located at the endothelium suggests that this molecule could be a more specific marker of a high risk for ICH after MI. This hypothesis is supported by our finding that c-Fn levels, but not MMP-9 levels, remained independently associated with ICH after MI in the logistic regression analysis.

The basal lumina disruption and the subsequent release of c-Fn after brain ischemic injury into the plasma, as well as accelerated Fn synthesis by endothelial cells and other cells such as polymorphonuclear leukocytes arriving at the ischemic tissue as part of the ischemic inflammatory cascade, could be among the participating mechanisms. Interleukins and transforming growth factor, whose expression is increased as a result of ischemia (see for instance Feuerstein G Z, Wang X, Barone F C. Inflammatory mediators and brain injury: the role of cytokines and chemokines in stroke and CNS diseases. In: Ginsberg M D, Bogousslavsky J, eds. Cerebrovascular Disease: Pathophysiology, Diagnosis, and Management. Boston, Mass: Blackwell Science; 1998:507-531.), have been shown to stimulate Fn synthesis (see for instance Roberts C J, Birkenmeier T M, McQuillar J J, Akiyama S K, Yamada S S, Chen W T, Yamada K M, McDonald J A. Transforming growth factor beta stimulates the expression of fibronectin and of both subunits of the human fibronectin receptor by cultured human lung fibroblast. J Biol Chem. 1988; 263:4586-4592.). Increased c-Fn synthesis could be an attempt to decrease endothelial destruction by MMPs, which might explain the positive correlation between c-Fn and MMP-9 in the instant invention.

The approach of testing multiple markers is well established in the clinical setting of suspected myocardial ischemia. In acute coronary syndromes, the myocardial isoform of creatinine phosphokinase and troponin play an important role both in treatment decisions and clinical research. Similarly, B-type natriuretic peptide has become a routine part of the assessment of patients with congestive heart failure and dyspnea. However, until the instant invention no one individual biochemical marker has been demonstrated to possess the requisite sensitivity and specificity to allow it to function independently as a clinically useful diagnostic marker for vascular damage, prediction of bleeding events, or in prediction of ICH in MI patients given a thrombolytic.

In many studies, many blood-borne proteomic markers have been shown to be associated with stroke and its sub-types. For example, acute stroke has been associated with serum elevations of numerous inflammatory and anti-inflammatory mediators such as interleukin 6 (IL-6) and matrix metalloproteinase-9 (MMP-9) (see for instance Kim J S, Yoon S S, Kim Y H, Ryu J S. Serial measurement of interleukin-6, transforming growth factor-beta, and S-100 protein in patients with acute stroke. Stroke. 1996; 27:1553-1557.; Dziedzic T, Bartus S, Klimkowicz A, Motyl M, Slowik A, Szczudlik A. Intracerebral hemorrhage triggers interleukin-6 and interleukin-10 release in blood. Stroke. 2002; 33:2334-2335.; Beamer N B, Coull B M, Clark W M, Hazel J S, Silberger J R. Interleukin-6 and interleukin-1 receptor antagonist in acute stroke. Ann Neurol. 1995; 37:800-805.; Montaner J, Alvarez-Sabin J, Molina C, et al. Matrix metalloproteinase expression after human cardioembolic stroke: temporal profile and relation to neurological impairment. Stroke. 2001; 32:1759-1766.; Perini F, Morra M, Alecci M, Galloni E, Marchi M, Toso V. Temporal profile of serum anti-inflammatory and pro-inflammatory interleukins in acute ischemic stroke patients. Neurol Sci. 2001; 22:289-296.; Vila N, Castillo J, Davalos A, Chamorro A. Proinflammatory cytokines and early neurological worsening in ischemic stroke. Stroke. 2000; 31: 2325-2329), markers of impaired hemostasis and thrombosis (see for instance Fon E A, Mackey A, Cote R, et al. Hemostatic markers in acute transient ischemic attacks. Stroke. 1994; 25:282-286.; Takano K, Yamaguchi T, Uchida K. Markers of a hypercoagulable state following acute ischemic stroke. Stroke. 1992; 23:194-198.), and markers of glial activation such as S100b (see for instance Buttner T, Weyers S, Postert T, Sprengelmeyer R, Kuhn W. S-100 protein: serum marker of focal brain damage after ischemic territorial MCA infarction. Stroke. 1997; 28:1961-1965.; Martens P, Raabe A, Johnsson P. Serum S-100 and neuron-specific enolase for prediction of regaining consciousness after global cerebral ischemia. Stroke. 1998; 29:2363-2366.). Several of these mediators, including IL-6, have been shown to be elevated within hours after ischemia and correlate with infarct volume (see for instance Fassbender K, Rossol S, Kammer T, et al. Proinflammatory cytokines in serum of patients with acute cerebral ischemia: kinetics of secretion and relation to the extent of brain damage and outcome of disease. J Neurol Sci. 1994; 122:135-139.; Tarkowski E, Rosengren L, Blomstrand C, et al. Early intrathecal production of interleukin-6 predicts the size of brain lesion in stroke. Stroke. 1995; 26:1393-1398).

Other authors have looked at the differentiation between TIA and stroke (see for instance Dambinova S A, Khounteev G A, Skoromets A A. Multiple panel of biomarkers for TIA/stroke evaluation. Stroke. 2002; 33:1181-1182.) or type of hemorrhage (see for instance McGirt M J, Lynch J R, Blessing R, Warner D S, Friedman A H, Laskowitz D T. Serum von Willebrand factor, matrix metalloproteinase-9, and vascular endothelial growth factor levels predict the onset of cerebral vasospasm after aneurysmal subarachnoid hemorrhage. Neurosurgery. 2002; 51:1128-1134).

Another example of the state of the art is the series of U.S. Pat. Nos. 7,049,397, 6,627,606, 6,617,308, 6,602,855, and 6,593,298. In these patents, a a biomarker of weight 1211, 1465, 1865, 1449, and 1690 daltons, respectively, is claimed for the diagnosis of myocardial infarction, congestive heart failure or intracerebral hemorrhage. The instant invention claims different proteins than said patent, and is prognostic of bleeding events in cardiovascular conditions such as MI, including ICH, following the administration of a therapeutic, rather than just a diagnostic of the cardiovascular event itself. In addition, no disease threshold for said biomarkers is taught, and thus significant experiments still needs to be done in order by person trained in the art to carry out the specification of the claims. Similarly, U.S. patent application Ser. No. 11/388,156 relates to the use of glial fibrillary acidic protein (GFAP) as a diagnostic marker for intracerebral hemorrhage. Again, this invention is concerning a different molecule than the ones described in the instant invention, only relates to post-occurrence differentiation between ICH and ischemic stroke and not prediction of treatment-induced ICH in cardiovascular disease, and does not envision a algorithm-driven multiple-marker test to increase accuracy of such a test. More similarly, U.S. patent application Ser. No. 11/338,447 relates to the use of levels of an NMDA receptor peptide or antibody such as NR2a for aiding in the assessment of the risk of stroke in an apparently healthy human subject prior to surgery. Again, this invention is concerning a different molecule than the ones described in the instant invention. Additionally, the type of stroke as is apparent in the claims of U.S. patent application Ser. No. 11/338,447 is ischemic, not hemorrhagic stroke, and the usage of the molecular test is before surgery such as surgery after MI, not the administration of a therapeutic, such as the administration of a thrombolytic after MI.

Accordingly, the instant invention provides a methodology to predict bleeding and ICH risk in cardiovascular patients that are treated therapeutically or with a device to restore antegrade flow in the infarct vessel or prevent atherosclerotic buildup.

Exemplary Biomarkers related to detection and prediction of adverse stroke outcomes.

A comprehensive methodology for identification of one or more markers for the prognosis, diagnosis, and detection of hemorrhagic stroke has been described previously. Suitable methods for identifying such diagnostic, prognostic, or disease-detecting markers are described in detail in U.S. patent application Ser. No. 11/046,592, entitled CELLULAR FIBRONECTIN AS A DIAGNOSTIC MARKER OF STROKE AND METHODS OF USE THEREOF, filed Jan. 29, 2005, each of which patents and relevant applications is hereby incorporated by reference in its entirety, including all tables, figures, and claims. Briefly, our method of predicting relevant markers given an individual's test sample is an automated technique of constructing an optimal mapping between a given set of input marker data and a given clinical variable of interest. We illustrate this method, as well as additional marker descriptions, further in the U.S. patent application Ser. No. 11/346,862.

We first obtain patient test samples of some bodily fluid, such as blood, cerebrospinal fluid, or urine from two or more groups of patients who suffered some sort of bleeding event after treatment for a cardiovascular event, such as MI. Preferred fluid is blood. The patients are those exhibiting symptoms of a bleeding event after treatment, say ICH, which is determined at a later time, and those who did not suffer a bleeding event after treatment, which are viewed as controls, though these patients might have another disease event distinct from the first. Samples from these patients are taken at various time periods after the event has occurred, and assayed for various markers as described within. Clinical information, such as sex, age, time from onset of symptoms to treatment, NIHSS score, biochemistry and vital signs at admission, and neuroimaging findings are collected at various time periods. Preferred time periods for the instant invention include 0, 3 hours, 6 hours, 9 hours, 12 hours, 15 hours, 18 hours, 24 hours, 36 hours, 48 hours, 72 hours, 1 week, 2 weeks, 3 weeks, 4 weeks, 3 months and 6 months. Time is measured either from onset of symptoms or admission into a clinical setting where the patient receives care. This marker and clinical information form a set of examples of clinical inputs and their corresponding outputs, the outputs being the clinical outcome of interest, for instance stroke and stroke subtype occurrence or non-occurrence, or occurrence and type of major bleed. The therapeutic used to restore antegrade flow in the infarct vessel or prevent atherosclerotic buildup is also noted. These quantities are as described in the Introduction.

We then use an algorithm to select the most relevant clinical inputs that correspond to the outcome for each time period. This process is also known as feature selection. In this process, the minimum number of relevant clinical inputs that are needed to fully differentiate and/or predict disease prognosis, diagnosis, or detection with the highest sensitivity and specificity are selected for each time period. The feature selection is done with an algorithm that selects markers that differentiate between patient disease groups, say major bleeds versus ICH. The relevant clinical input combinations might change at different time periods, and might be different for different clinical outcomes of interest.

We then train a classifier to map the selected relevant clinical inputs to the outputs. A classifier assigns relative weightings to individual marker values. We note that the construct of a classifier is not crucial to our method. Any mapping procedure between inputs and outputs that produces a measure of goodness of fit, for example, maximizing the area under the receiver operator curve of sensitivity versus 1-specificity, for the training data and maximizes it with a standard optimization routine on a series of validation sets would also suffice.

Once the classifier is trained, it is ready for use by a clinician. The clinician enters the same classifier inputs used during training of the network by assaying the selected markers and collecting relevant clinical information for a new patient, and the trained classifier outputs a maximum likelihood estimator for the value of the output given the inputs for the current patient. The clinician or patient can then act on this value. We note that a straightforward extension of our technique could produce an optimum range of output values given the patient's inputs as well as specific threshold values for inputs.

One versed in the ordinary state of the art knows that many other markers in the literature once measured from the blood in a diseased and healthy patient, selected through use of an feature selection algorithm might be diagnostic of cardiovascular events if measured in combination with others and evaluated together with a nonlinear classification algorithm. We have previously described some of these other markers considered for diagnosis or prognosis of cardiovascular events in U.S. patent application Ser. Nos. 10/673,077, 10/714,078 and/or 11/046,592, all of which are incorporated herein, and thus the descriptions of said markers is not repeated in this application. The list referred to in U.S. patent application Ser. Nos. 10/673,077, 10/714,078 and/or 11/046,592 is meant to serve as illustrative and not meant to be exhaustive.

How to Measure Various Markers

One of ordinary skill in the art know several methods and devices for the detection and analysis of the markers of the instant invention. With regard to polypeptides or proteins in patient test samples, immunoassay devices and methods are often used. These devices and methods can utilize labeled molecules in various sandwich, competitive, or non-competitive assay formats, to generate a signal that is related to the presence or amount of an analyte of interest. Additionally, certain methods and devices, such as biosensors and optical immunoassays, may be employed to determine the presence or amount of analytes without the need for a labeled molecule.

Preferably the markers are analyzed using an immunoassay, although other methods are well known to those skilled in the art (for example, the measurement of marker RNA levels). The presence or amount of a marker is generally determined using antibodies specific for each marker and detecting specific binding. Any suitable immunoassay may be utilized, for example, enzyme-linked immunoassays (ELISA), radioimmunoassay (RIAs), competitive binding assays, and the like. Specific immunological binding of the antibody to the marker can be detected directly or indirectly. Direct labels include fluorescent or luminescent tags, metals, dyes, radionuclides, and the like, attached to the antibody. Indirect labels include various enzymes well known in the art, such as alkaline phosphatase, horseradish peroxidase and the like. For an example of how this procedure is carried out on a machine, one can use the RAMP Biomedical device, called the Clinical Reader sup.TM., which uses the fluorescent tag method, though the skilled artisan will know of many different machines and manual protocols to perform the same assay. Diluted whole blood is applied to the sample well. The red blood cells are retained in the sample pad, and the separated plasma migrates along the strip. Fluorescent dyed latex particles bind to the analyte and are immobilized at the detection zone. Additional particles are immobilized at the internal control zone. The fluorescence of the detection and internal control zones are measured on the RAMP Clinical Reader sup.TM., and the ratio between these values is calculated. This ratio is used to determine the analyte concentration by interpolation from a lot-specific standard curve supplied by the manufacturer in each test kit for each assay.

The use of immobilized antibodies specific for the markers is also contemplated by the present invention and is well known by one of ordinary skill in the art. The antibodies could be immobilized onto a variety of solid supports, such as magnetic or chromatographic matrix particles, the surface of an assay place (such as microtiter wells), pieces of a solid substrate material (such as plastic, nylon, paper), and the like. An assay strip could be prepared by coating the antibody or a plurality of antibodies in an array on solid support. This strip could then be dipped into the test sample and then processed quickly through washes and detection steps to generate a measurable signal, such as a colored spot.

The analysis of a plurality of markers may be carried out separately or simultaneously with one test sample. Several markers may be combined into one test for efficient processing of a multiple of samples. In addition, one skilled in the art would recognize the value of testing multiple samples (for example, at successive time points) from the same individual. Such testing of serial samples will allow the identification of changes in marker levels over time. Increases or decreases in marker levels, as well as the absence of change in marker levels, would provide useful information about the disease status that includes, but is not limited to identifying the approximate time from onset of the event, the presence and amount of salvageable tissue, the appropriateness of drug therapies, the effectiveness of various therapies, identification of the severity of the event, identification of the disease severity, and identification of the patient's outcome, including risk of future events.

An assay consisting of a combination of the markers referenced in the instant invention may be constructed to provide relevant information related to differential diagnosis. Such a panel may be constructed using 1, 2, 3, 4, 5, 6, 7, 8, 9, 10, 15, 20, or more or individual markers, though a number lower than 4 markers is the most preferred embodiment. The analysis of a single marker or subsets of markers comprising a larger panel of markers could be carried out methods described within the instant invention to optimize clinical sensitivity or specificity in various clinical settings. The clinical sensitivity of an assay is defined as the percentage of those with the disease that the assay correctly predicts, and the specificity of an assay is defined as the percentage of those without the disease that the assay correctly predicts (Tietz Textbook of Clinical Chemistry, 2.sup.nd edition, Carl Burtis and Edward Ashwood eds., W. B. Saunders and Company, p. 496).

The analysis of markers could be carried out in a variety of physical formats as well. For example, the use of microtiter plates or automation could be used to facilitate the processing of large numbers of test samples. Alternatively, single sample formats could be developed to facilitate immediate treatment and diagnosis in a timely fashion, for example, in ambulatory transport or emergency room settings. Particularly useful physical formats comprise surfaces having a plurality of discrete, addressable locations for the detection of a plurality of different analytes. Such formats include protein microarrays, or “protein chips” (see, e.g., Ng and Ilag, J. Cell Mol. Med. 6: 329-340 (2002)) and capillary devices.

In another embodiment, the present invention provides a kit for the analysis of markers. Such a kit preferably comprises devises and reagents for the analysis of at least one test sample and instructions for performing the assay. Optionally the kits may contain one or more means for using information obtained from immunoassays performed for a marker panel to rule in or out certain diagnoses. Marker antibodies or antigens may be incorporated into immunoassay diagnostic kits depending upon which marker autoantibodies or antigens are being measured. A first container may include a composition comprising an antigen or antibody preparation. Both antibody and antigen preparations should preferably be provided in a suitable titrated form, with antigen concentrations and/or antibody titers given for easy reference in quantitative applications.

The kits may also include an immunodetection reagent or label for the detection of specific immunoreaction between the provided antigen and/or antibody, as the case may be, and the diagnostic sample. Suitable detection reagents are well known in the art as exemplified by radioactive, enzymatic or otherwise chromogenic ligands, which are typically employed in association with the antigen and/or antibody, or in association with a second antibody having specificity for first antibody. Thus, the reaction is detected or quantified by means of detecting or quantifying the label. Immunodetection reagents and processes suitable for application in connection with the novel methods of the present invention are generally well known in the art.

The reagents may also include ancillary agents such as buffering agents and protein stabilizing agents, e.g., polysaccharides and the like. The diagnostic kit may further include where necessary agents for reducing background interference in a test, agents for increasing signal, software and algorithms for combining and interpolating marker values to produce a prediction of clinical outcome of interest, apparatus for conducting a test, calibration curves and charts, standardization curves and charts, and the like.

In a preferred embodiment the invention relates to a kit for detecting various markers indicative of bleed or ICH risk prediction comprising: (1) an immunosorbent for selected markers indicative of bleed or ICH risk prediction, and (2) an indicator reagent comprising secondary antibodies attached to a signal generating compound for each individual marker. The secondary antibodies can be specific for each individual marker or for the primary antibodies in the immunosorbent. In a preferred embodiment the kits further comprise an immunosorbent for glutamate or polyglutamate, and/or an immunosorbent for homocysteine or polyhomocysteine, and secondary antibodies against the glutamate and/or homocysteine, or to the primary antibodies on the immunosorbents against the glutamate or homocysteine. The immunosorbent preferably comprises anti-antibodies for the biomarkers bound to a solid support.

Another preferred embodiment of the instant invention is described in U.S. Pat. No. 7,018,849, which uses superparamagnetic particles coated with a material that is a binding parter for the target molecule(s), in the instant invention indicative of bleed or ICH risk prediction. The coated superparamagnetic particles are then immersed in blood taken from the patient and incubated for a period preferably under 15 minutes, most preferably under 7 minutes. Complexes of superparamagnetic particles and target ligand are thereby formed. These complexes are sequestered from the bulk of liquid sample by exposure to the gradient of a magnetic field. The liquid is then removed by aspiration, decanting or any other convenient method the particles are washed and dispersed in a volume of a suitable buffer that is smaller than the volume of the original sample. An ICT strip of nitrocellulose or other bibulous material upon which a stripe of binding partner for the target molecule—which may be the same one used in the concentration step or a different one, depending upon the functionality of the target molecule—has been immovably bound to the capture zone area, contained in a “dipstick” ICT device format, is immersed in the buffered dispersion of superparamagnetic particles complexes. Upon migration of these particles complexes along the strip, the target molecule on their outer surface binds to its binding partner in the immovable stripe, causing superparamagnetic particles to accumulate along the stripe. Experience has shown that immovable striping of binding partner for the target molecule multiple lines, spaced apart from one another along the end of the strip remote from the sample receiving end, may be appropriate to ensure efficient capture of the target ligand in this assay. The magnetic signal of the superparamagnetic tag on the capture line or lines in millivolts, is read in a suitable instrument.

In another aspect the present invention relates to a test-kit that relies upon PCR amplification for measuring selected markers indicative of bleed or ICH risk prediction. Thus, in another embodiment the invention provides a kit comprising: (a) one or more oligonucleotide primers attached to a solid phase, (b) indicator reagent attached to a signal-generating compound capable of generating a detectable signal from oligonucleotides, and (c) a control sample (i.e. template cDNA). The reagents may also include ancillary agents such as buffering agents, polymerase agents, and the like. The diagnostic kit may further include, where necessary, other members of the signal-producing system of which system the detectable group is a member (e.g., enzyme and non-enzyme substrates), agents for reducing background interference in a test, agents for increasing the signal, apparatus for conducting a test, and the like.

In another embodiment of test-kit comprises (a) a solid phase to which biological fluids for receiving total DNA including selected marker cDNA indicative of bleed or ICH risk prediction could be attached, (b) oligonucleotide primers, preferably in a ready-to-use PCR buffer, and (c) a control sample (i.e. template cDNA). Ancillary agents as described above may similarly be included.

In another embodiment the invention provides a diagnostic kit for detecting selected markers indicative of bleed or ICH risk prediction autoantibodies comprising (a) a polypeptide of the selected markers indicative of bleed or ICH risk prediction, fragment thereof, or analog or derivative thereof, (b) an indicator reagent comprising a secondary antibody specific for the autoantibody or the polypeptide attached to a signal-generating compound; and (c) a control sample, such as a known concentration of said selected markers indicative of bleed or ICH risk prediction diagnosis polyclonal antibodies. The reagents may also include ancillary agents such as buffering agents and protein stabilizing agents, e.g., polysaccharides and the like. The diagnostic kit may further include, where necessary, other members of the signal-producing system of which system the detectable group is a member (e.g., enzyme and non-enzyme substrates), agents for reducing background interference in a test, agents to increase the signal, apparatus for conducting a test, calibration and standardization information or instructions, and the like.

Methodology of Marker Selection, Analysis, and Classification

Non-linear techniques for data analysis and information extraction are important for identifying complex interactions between markers that contribute to overall presentation of the clinical outcome. However, due to the many features involved in association studies such as the one proposed, the construction of these in-silico predictors is a complex process. Often one must consider more markers to test than samples, missing values, poor generalization of results, selection of free parameters in predictor models, confidence in finding a sub-optimal solution and others. Thus, the process for building a predictor is as important as designing the protocol for the association studies. Errors at each step can propagate downstream, affecting the generalizability of the final result.

We now provide a brief overview of our process of model development, describing the five main steps and some techniques that the instant invention may use to build an optimal biomarker panel of response for each clinical outcome. A fuller description is given in U.S. patent application Ser. No. 11/046,592 and related applications. One of ordinary skill in the art will know that it is best to use a ‘toolbox’ approach to the various steps, trying several different algorithms at each step, and even combining several as in Step Five. Since one does not know a priori the distribution of the true solution space, trying several methods allows a thorough search of the solution space of the observed data in order to find the most optimal solutions (i.e. those best able to generalize to unseen data). One also can give more confidence to predictions if several independent techniques converge to a similar solution.

Method for Defining Panels of Markers

In practice, data may be obtained from a group of subjects. The subjects may be patients who have been tested for the presence or level of certain markers. Such markers and methods of patient extraction are well known to those skilled in the art. A particular set of markers may be relevant to a particular condition or disease. The method is not dependent on the actual markers. The markers discussed in this document are included only for illustration and are not intended to limit the scope of the invention. Examples of such markers and panels of markers are described in the instant invention and the incorporated references.

Well-known to one of ordinary skill in the art is the collection of patient samples. A preferred embodiment of the instant invention is that the samples come from two or more different sets of patients, one a disease group of interest and the other(s) a control group, which may be healthy or diseased in a different indication than the disease group of interest. For instance, one might want to look at the difference in blood-borne markers between patients who have had an ICH following thrombolytic treatment for MI and those who did not have any bleeding or ICH following thrombolytic treatment for MI to differentiate between the two populations.

The blood samples are assayed, and the resulting set of values are put into a database, along with outcome, also called phenotype, information detailing the side effect of treatment, for instance ICH, once this is known. Additional clinical details such as time from onset of symptoms and patient physiological, medical, and demographics, the sum total called patient characteristics, are put into the database. The time from onset is important to know as initial marker values from onset of symptoms can change significantly over time on a timeframe of tens of minutes. Thus, a marker may be significant at one point in the patient history and not at another in predicting diagnosis or prognosis of cardiovascular disease, damage or injury. The database can be simple as a spreadsheet, i.e. a two-dimensional table of values, with rows being patients and columns being filled with patient marker and other characteristic values.

From this database, a computerized algorithm can first perform pre-processing of the data values. This involves normalization of the values across the dataset and/or transformation into a different representation for further processing. The dataset is then analyzed for missing values. Missing values are either replaced using an imputation algorithm, in a preferred embodiment using KNN or MVC algorithms, or the patient attached to the missing value is excised from the database. If greater than 50% of the other patients have the same missing value then value can be ignored.

Once all missing values have been accounted for, the dataset is split up into three parts: a training set comprising 33-80% of the patients and their associated values, a testing set comprising 10-50% of the patients and their associated values, and a validation set comprising 1-50% of the patients and their associated values. These datasets can be further sub-divided or combined according to algorithmic accuracy. A feature selection algorithm is applied to the training dataset. This feature selection algorithm selects the most relevant marker values and/or patient characteristics. Preferred feature selection algorithms include, but are not limited to, Forward or Backward Floating, SVMs, Markov Blankets, Tree Based Methods with node discarding, Genetic Algorithms, Regression-based methods, kernel-based methods, and filter-based methods.

Feature selection is done in a cross-validated fashion, preferably in a naïve or k-fold fashion, as to not induce bias in the results and is tested with the testing dataset. Cross-validation is one of several approaches to estimating how well the features selected from some training data is going to perform on future as-yet-unseen data and is well-known to the skilled artisan. Cross validation is a model evaluation method that is better than residuals. The problem with residual evaluations is that they do not give an indication of how well the learner will do when it is asked to make new predictions for data it has not already seen. One way to overcome this problem is to not use the entire data set when training a learner. Some of the data is removed before training begins. Then when training is done, the data that was removed can be used to test the performance of the learned model on “new” data.

Once the algorithm has returned a list of selected markers, one can optimize these selected markers by applying a classifier to the training dataset to predict clinical outcome. A cost function that the classifier optimizes is specified according to outcome desired, for instance an area under receiver-operator curve maximizing the product of sensitivity and specificity of the selected markers, or positive or negative predictive accuracy. Testing of the classifier is done on the testing dataset in a cross-validated fashion, preferably naïve or k-fold cross-validation. Further detail is given in U.S. patent application Ser. No. 09/611,220, incorporated by reference. Classifiers map input variables, in this case patient marker values, to outcomes of interest, for instance, prediction of stroke sub-type. Preferred classifiers include, but are not limited to, neural networks, Decision Trees, genetic algorithms, SVMs, Regression Trees, Cascade Correlation, Group Method Data Handling (GMDH), Multivariate Adaptive Regression Splines (MARS), Multilinear Interpolation, Radial Basis Functions, Robust Regression, Cascade Correlation+Projection Pursuit, linear regression, Non-linear regression, Polynomial Regression, Regression Trees, Multilinear Interpolation, MARS, Bayes classifiers and networks, and Markov Models, and Kernel Methods.

The classification model is then optimized by for instance combining the model with other models in an ensemble fashion. Preferred methods for classifier optimization include, but are not limited to, boosting, bagging, entropy-based, and voting networks. This classifier is now known as the final predictive model. The predictive model is tested on the validation data set, not used in either feature selection or classification, to obtain an estimate of performance in a similar population.

The predictive model can be translated into a decision tree format for subdividing the patient population and making the decision output of the model easy to understand for the clinician. The marker input values might include a time since symptom onset value and/or a threshold value. Using these marker inputs, the predictive model delivers diagnositic or prognostic output value along with associated error. The instant invention anticipates a kit comprised of reagents, devices and instructions for performing the assays, and a computer software program comprised of the predictive model that interprets the assay values when entered into the predictive model run on a computer. The predictive model receives the marker values via the computer that it resides upon.

### BRIEF DESCRIPTION OF THE DRAWINGS

In the following, the invention will be explained in further detail with reference to the drawings, in which:

FIG. 1 is a table illustrating clinical parameters among a set of patients who suffered an MI and a stroke after administration of thrombolytic therapy and a set of patients who did not suffer a stroke when given thrombolytic therapy;

FIG. 2 is a Kruskill-Wallis plot showing c-Fn plasma molecular levels cardioembolic stroke patients who did and did not suffer an ICH after administration of thrombolytic therapy and a set of non-cardioembolic stroke patients who did and did not suffer an ICH when given thrombolytic therapy;

FIG. 3 is a scatter plot showing MMP-9 values divided by 30 on the x-axis plotted against c-Fn values on the y-axis for cardiac patients who suffered a MI and a bleeding event after administration of thrombolytic therapy. −9 is no data available, −1 is unknown outcome, 0 is normals healthy controls, 1 is HI-1 events, 2 is HI-2 events, 3 is PH-1 events, 4 is PH-2 events.

### EXAMPLE I

### Patients and Methods

In a prospective, multicenter study performed to identify predictors of hemorrage, a cohort of patients with a cardiovascular event such as MI or cardioembolic stroke and then were given a thrombolytic were analyzed (n=98). Patients were administered a thrombolytic within 12 hours of onset of symptoms. Exclusion criteria were age younger than 18, reasons for exclusion were known infectious, inflammatory, or neoplastic diseases at the time of treatment and nonavailability of blood samples at baseline. On arrival to the emergency department, blood pressure and body temperature were recorded and blood samples were taken. Each MI patient underwent a 12-lead electrocardiogram and subsequent evaluation of elevated ST segment. Each stroke patient underwent a baseline head CT scan if suspected and a Canadian Stroke Scale (CSS) evaluation by an experienced neurologist. Patients were admitted to a neurological ward or an acute cardiovascular unit and were treated by a specialized stroke team and nursing staff following established guidelines.

ICH was diagnosed when the National Institutes of Health Stroke Scale score worsened by ≧4 points between baseline and 24 hours, and confirmed by CT scan. CT scans were performed immediately before treatment and at 24 to 36 hours after thrombolytic therapy or on neurologic deterioration. According to the European-Australasian Acute Stroke Study II definitions, HT was classified as hemorrhagic infarction type 1 or type 2, and PH, as type 1, type 2, or remote PH. As specified earlier, relevant HT was defined as hemorrhagic infarction type 2 and any type of PH. HT was defined as symptomatic when it was associated with early neurologic deterioration. CT scans were evaluated by investigators who were blinded to the laboratory determinations and clinical outcome. Lesion volumes were calculated on the radiographic plate using the formula 0.5×a×b×c (where a is the maximal longitudinal diameter, b is the maximal transverse diameter, and c is the number of 10-mm slices containing hemorrhage). The volume of the ICH plus that of the zone of peripheral hypodensity was determined using the same volumetric method described; the absolute volume of the hypodensity was calculated by subtracting the volume of the ICH from that of the total lesion (ICH plus peripheral hypodensity).

Laboratory Tests

Blood samples were collected on admission in tubes with potassium edetate, centrifuged at 3000 g for 5 minutes, and immediately frozen and stored at −80°. IL-6 and tumor necrosis factor-alpha (TNF-α) were measured with commercially available quantitative sandwich enzyme-linked immunosorbent assay (Quantikine) kits obtained from R&D Systems. MMP-9 was measured with commercially available quantitative sandwich enzyme-linked immunosorbent assay kits obtained from Biotrack Amersham Pharmacia, UK. c-Fn was measured with enzyme-linked immunosorbent assay kits obtained from BioHit Plc Finland. Laboratory determinations were performed blinded to clinical and neuroimaging findings.

Statistical Analysis

Proportions between groups were compared using the χ² test. Continuous variables are expressed as mean ±SD and were compared using the Student t test. Given that MMP-9 and c-Fn concentrations are not normally distributed, their levels were expressed as median (quartiles), and comparisons were made using the Mann-Whitney test or Kruskal-Wallis test as appropriate. The association between c-Fn levels and baseline continuous variables was assessed by calculating the Spearman correlation coefficient.

Results

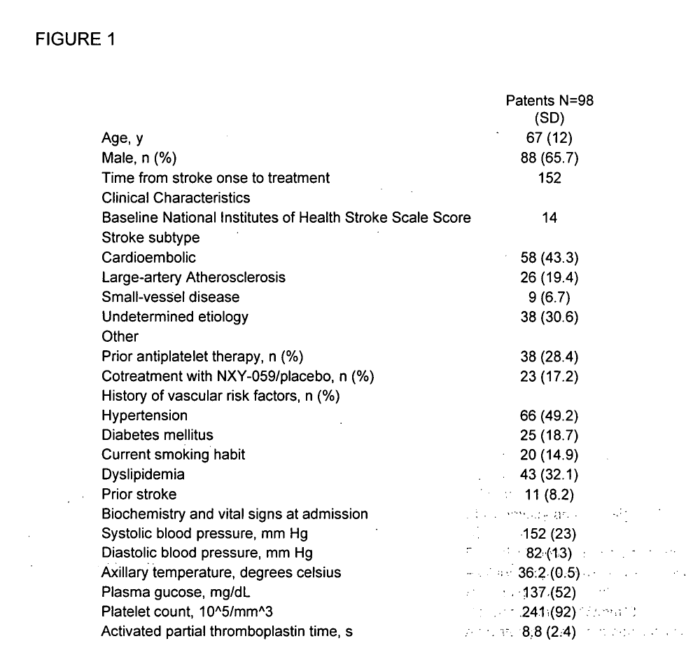

Potential predictors of evolution to ICH after thrombolytic therapy in the bivariate analysis are shown in FIG. 1 for the full cohort of 151 patients, 98 of which were included in the cohort as being cardiovascular in origin. Age, gender, frequency of risk factors, time from symptoms onset to admission, CSS score, body temperature, and blood pressure were similar in both groups.

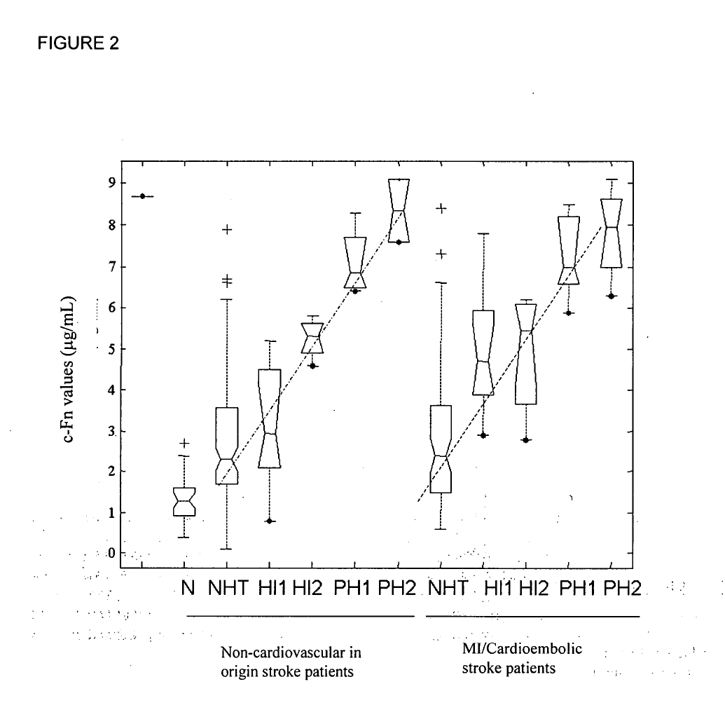

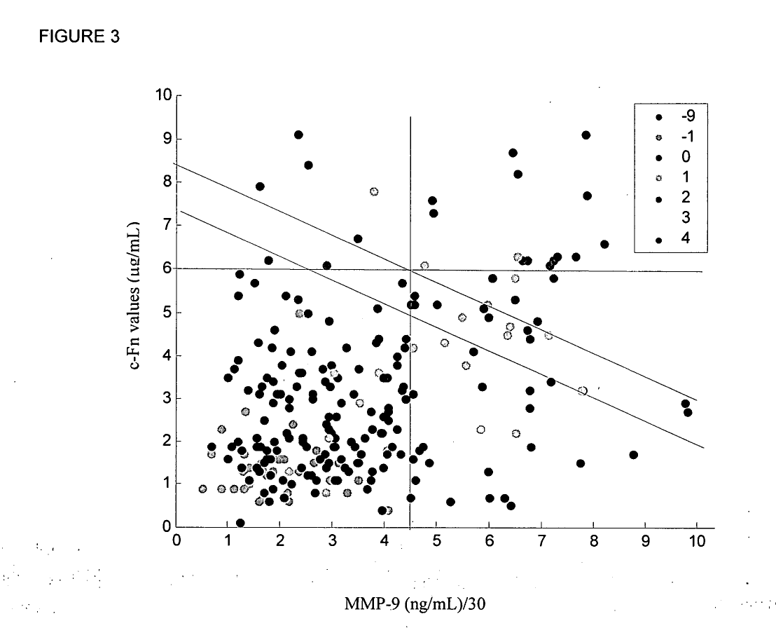

Plasma concentrations of MMP-9, and c-Fn were significantly higher in patients with evolution to ICH after thrombolytic therapy (FIG. 2 and FIG. 3), however IL-6 and TNF-α were not. Similar results were found in the cardiovascular cohort (MI and cardioembolic strokes) than in the non-cardiovascular cohort (FIG. 2). In fact, the cardiovascular cohort had statistically higher levels of c-Fn in every radiological categorization of hemorrhage. FIG. 3 shows that MMP-9 and c-Fn together form a slightly better predictor of a hemorrhagic event, though for the PH-1 and PH-2 category, inclusive of all IHC events, c-Fn alone at a threshold level of 5.8 μg/mL is sufficient for prediction of evolution to IHC following thrombolytic therapy in cardiovascular patients (p=1.9391e-007).

This example shows that a plasma c-Fn concentration ≧5.8 μg/mL at admission predicts the development of PH after the administration of thrombolytic therapy. Using receiver-operator curve (ROC) analysis, (the ROC area under the curve was equal to 0.97; 95% Cl (0.94 to 0.99). Serum c-Fn levels ≧5.8 μg/mL predicted the development of PH after t-PA administration with a sensitivity of 100% (70% to 99%), a specificity of 88% (80% to 93%), a PPV of 45% (26% to 64%), an NPV of 100% (96% to 100%), and an accuracy of 89% (82% to 93%). Therefore, one can see that a test for the molecule c-Fn is of use in therapeutic decision making in treating cardiovascular events such as MI and cardioembolic stroke.

One skilled in the art readily appreciates that the present invention is well adapted to carry out the objects and obtain the ends and advantages mentioned, as well as those inherent therein. The examples provided herein are representative of preferred embodiments, are exemplary, and are not intended as limitations on the scope of the invention. Modifications therein and other uses will occur to those skilled in the art. These modifications are encompassed within the spirit of the invention and are defined by the scope of the claims.

It will be readily apparent to a person skilled in the art that varying substitutions and modifications may be made to the invention disclosed herein without departing from the scope and spirit of the invention.

All patents and publications mentioned in the specification are indicative of the levels of those of ordinary skill in the art to which the invention pertains. All patents and publications are herein incorporated by reference to the same extent as if each individual publication was specifically and individually indicated to be incorporated by reference.

The invention illustratively described herein suitably may be practiced in the absence of any element or elements, limitation or limitations which is not specifically disclosed herein. Thus, for example, in each instance herein any of the terms “comprising”, “consisting essentially of” and “consisting of” may be replaced with either of the other two terms. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

Other embodiments are set forth within the following claims.

We claim:

1. A method of determining presence, or risk, or presence and risk of bleeding events in human subject who has suffered from a cardiovascular event, particularity including a myocardial infarction (MI) cardiovascular event, the method comprising:
obtaining a test sample from the human subject;
analyzing the obtained test sample for amount of cellular fibronectin; and then
correlating (1) the analyzed amount of said cellular fibronectin with (2) clinical patient information, other than clinical patient information on the cellular fibronectin, in order to deduce a probability of present, or future, or both present and future, risk of bleeding events for the subject; and then
acting to administer therapy to the human subject for the cardiovascular event in accordance with the deduced probability.

2. The method according to claim 1
wherein the correlating is particularly so as to deduce a risk of a bleeding event following thrombolytic therapy.

3. The method according to claim 1 wherein the correlating is in order to deduce a probability of a present, or a future, or both a present and a future, risk of a bleeding event of the human subject in form of a bleeding event drawn from the group consisting of
intracerebral hemorrhage, and
a bleeding event requiring a blood transfusion for the subject.

4. The method according to claim 1 further comprising:
determining from the deduced probability when the subject is a myocardial infarction (MI) patient whether the subject MI patient is any of:
(1) at risk for a bleeding event prior to surgery;
(2) at risk for an intracerebral hemorrhage if given a thrombolytic;
(3) at an elevated risk of bleeding risk when given a combination antiplatelet/thienopyridine derivative therapy including aspirin or dipyridamole, and clopidogrel or ticlopidine; and
(4) potentially benefited by cardiac artery stenting or balloon angioplasty or both stenting and angioplasty.

5. The method according to claim 1
wherein the correlating is particularly so as to deduce the risk of a bleeding event following thrombolytic therapy selected from the group comprising tissue plasminogen activator (tPA or Alteplase), Accelerated Alteplase, Tenecteplase, Reteplase, Lanoteplase, urokinase and streptokinase.

6. The method of claim 1 wherein the correlating so as to further determine the relative risk of a bleeding event is, in addition to determining relative risk of a bleeding event in patients who have suffered a MI, expanded to predict risk of a bleeding event in patients who are suffering from cardiovascular disease.

7. The method of claim 1 wherein the correlating of clinical patient information is of clinical patient information is selected from a group consisting of Complete blood count (CBC), Coagulation test, Blood chemistry (glucose, serum electrolytes {Na, Ca, K}), Leukocyte and Neutrophil counts, platelet count, and Blood lipids tests.

8. The method of claim 1 wherein the correlating of clinical patient information is of clinical patient information is selected from a group consisting of age, weight, height, body mass index, computed tomography scan information, Magnet Resonance Image scan information, gender, time from onset of stroke-like symptoms, time to recanalization, ethnicity, heart rate, blood pressure, respiration rate, blood oxygenation, previous personal and/or familial history of cardiac events, recent cranial trauma and unequal eye dilation.

9. The method of claim 1
wherein the obtaining of the test sample from the human subject is within a specific time window from onset of symptoms; and
wherein the correlating is between (1) the amount of cellular fibronectin, and (2) the probability of present or future risk of a bleeding event for the human subject transpires within a first time window after onset of symptoms; and
wherein the acting to administer therapy is also within a second time window, equal to or longer than the first time window, after onset of symptoms.

10. The method of claim 9
Wherein the first and the second time window are each shorter than twelve hours.

11. A method of determining presence, or risk, or presence and risk of bleeding events in human subject who has suffered from a cardiovascular event, particularity including a myocardial infarction (MI) cardiovascular event, the method comprising:
obtaining a test sample from the human subject;
analyzing the obtained test sample for presence or amount of (1) cellular fibronectin and (2) one or more additional biomarkers of vascular damage, glial activation, inflammatory mediation, thrombosis, cellular injury, apoptosis, and myelin breakdown; and then
correlating (1) the presence or amount of said cellular fibronectin and said one or more additional biomarkers, with (2) clinical patient information, other than clinical patient information on the cellular fibronectin and one or more additional biomarkers, in order to deduce a probability of present, or future, or both present and future, risk of bleeding events for the subject; and then
acting to administer therapy to the human subject for the cardiovascular event in accordance with the deduced probability.

12. The method according to claim 11 wherein the correlating is in order to deduce a probability of a present, or a future, or both a present and a future, risk of a bleeding event of the human subject in form of a bleeding event drawn from the group consisting of
intracerebral hemorrhage, and
a bleeding event requiring a blood transfusion for the subject.

13. The method according to claim 11 further comprising:
determining from the deduced probability when the subject is a myocardial infarction (MI) patient whether the subject MI patient is any of:
(1) at risk for a bleeding event prior to surgery;
(2) at risk for an intracerebral hemorrhage if given a thrombolytic;
(3) at an elevated risk of bleeding risk when given a combination antiplatelet/thienopyridine derivative therapy including aspirin or dipyridamole, and clopidogrel or ticlopidine; and
(4) potentially benefited by cardiac artery stenting or balloon angioplasty or both stenting and angioplasty.

14. The method according to claim 11 wherein the correlating comprises:
determining expression levels of biomarker(s) from human subjects who have suffered from a side effect of treatment of a cardiovascular event;
comparing the determined expression levels to humans known to have not experienced the side effect of treatment for the cardiovascular event; and
training an algorithm to identify patterns of differences in the humans which patterns correlate with presence, or absence, of the side effect of treatment for cardiovascular event, respectively.

15. The method according to claim 14
wherein the training of the algorithm is on characteristic protein levels or patterns of differences; and
wherein the training of the algorithm includes the steps of
obtaining numerous examples of (i) said proteomic and non-proteomic data, and (ii) historical clinical results corresponding to this proteomic and non-proteomic data,
constructing an algorithm suitable to map (i) said protein expression levels and said non-proteomic values as inputs to the algorithm, to (ii) the historical clinical results as outputs of the algorithm,
exercising the constructed algorithm to so map (i) the said protein expression levels and said non-proteomic values as inputs to (ii) the historical clinical results as outputs, and
conducting an automated procedure to vary the mapping function, inputs to outputs, of the constructed and exercised algorithm in order that, by minimizing an error measure of the mapping function, a more optimal algorithm mapping architecture is realized;
wherein realization of the more optimal algorithm mapping architecture, also known as feature selection, means that any irrelevant inputs are effectively excised, meaning that the more optimally mapping algorithm will substantially ignore said protein expression levels and said non-proteomic values that are irrelevant to output clinical results; and
wherein realization of the more optimal algorithm mapping architecture, also known as feature selection, also means that any relevant inputs are effectively identified, making that the more optimally mapping algorithm will serve to identify, and use, those input protein expression levels and said non-proteomic values that are relevant, in combination, to output clinical results that would result in a clinical detection of a bleeding event, deduction of future risk of a bleeding event, or prediction of outcome of a certain treatment course or a combination of any two, three or four of these actions.

16. The method according to claim 15 wherein the constructed algorithm is drawn from the group consisting essentially of:
linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; a plurality of algorithms arranged in a committee network; and forward floating search or backward floating search algorithms.

17. The method according to claim 15 wherein the feature selection process employs an algorithm drawn from the group consisting essentially of:
linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; recursive feature elimination or entropy-based recursive feature elimination algorithms; a plurality of algorithms arranged in a committee network; and forward floating search or backward floating search algorithms.

18. The method according to claim 15
wherein a tree algorithm is trained to reproduce the performance of another machine-learning classifier or regressor by enumerating the input space of said classifier or regressor to form a plurality of training examples sufficient (1) to span the input space of said classifier or regressor and (2) train the tree to emulate the performance of said classifier or regressor.

19. The method according to claim 18
wherein the correlating is particularly so as to deduce the risk of a bleeding event following thrombolytic therapy selected from the group comprising tissue plasminogen activator (tPA or Alteplase), Accelerated Alteplase, Tenecteplase, Reteplase, Lanoteplase, urokinase and streptokinase.

20. The method according to claim 11 wherein analyzing, and the correlating, of the one or more additional biomarkers is of biomarkers including, in addition to cellular fibronectin (c-Fn), one or more of the proteomic markers MMP-9, s-100β, IL-6, TNF-α, TAFI, and PAI-1.

21. The method according to claim 11 wherein analyzing, and the correlating, of the one or more additional biomarkers is of biomarkers including, in addition to cellular fibronectin (c-Fn), a proteomic marker of endothelial injury.

22. The method of claim 11 wherein the analyzing of one or more additional biomarkers in addition to cellular-fibronectin is of one or more biomarkers selected from the group consisting of two or more of the following: Glial fibrillary acidic protein, apolipoprotein CI (ApoC-I), apolipoprotein CIII (ApoC-III), serum amyloid A (SAA), Platelet factor 4 (PF4), platelet-derived growth factor, antithrombin-III fragment (AT-III fragment), bradykinin, renin, haptoglobin, Creatine kinase brain band (CK-BB), adenylate kinase, lactate dehydrogenase, troponin I, troponin T, Brain Derived Neurotrophic Factor, CPK, LDH Isoenzymes, Thrombin-Antithrombin III, calcitonin, procalcitonin, c-tau, Protein C, Protein S, fibrinogen, Factor VIII, activated Protein C resistance, E-selectin, P-selectin, von Willebrand factor (vWF), platelet-derived microvesicles (PDM), plasminogen activator inhibitor-1 (PAI-1), angiotensin I, angiotensin II, angiotensin III, annexin V, arginine vasopressin, B-type natriuretic peptide (BNP), pro-BNP, atrial natriuretic peptide (ANP), N-terminal pro-ANP, pro-ANP, C-type natriuretic peptide, (CNP), c-fos, c-jun, ubiquitin, cytochrome C, beta-enolase, cardiac troponin I, cardiac troponin T, urotensin II, creatine kinase-MB, glycogen phosphorylase-BB, KL-6, endothelin-1, endothelin-2, and endothelin-3, A-, F-, and H-Fatty acid binding protein (A-, F-, H-FABP), phosphoglyceric acid mutase-MB, aldosterone, S-100beta (S100β), myelin basic protein, NR2A or NR2B NMDA receptor or fragment thereof (a subtype of N-methyl-D-aspartate (NMDA) receptors), Intracellular adhesion molecule (ICAM or CD54), Neuronal cell adhesion molecule, (NCAM or CD56), C-reactive protein, caspase-3, cathepsin D, hemoglobin alpha.sub.2, human lipocalin-type prostaglandin D synthase, interleukin-1 beta, interleukin-1 receptor angonist, interleukin 2, interleukin 2 receptor, interleukin-6, IL-1, IL-8, IL-10, monocyte chemotactic protein-1, soluble intercellular adhesion molecule-1, soluble vascular cell adhesion molecule-1, MMP-2, MMP-3, MMP-9, MMP-12, MMP-9, tissue factor (TF), NDKA, RAGE, RNA-BP, TRAIL, TWEAK, UFD1, fibrin D-dimer (D-dimer), total sialic acid (TSA), TpP, heat shock protein 60, heat shock protein 70, tumor necrosis factor alpha, tumor necrosis factor receptors 1 and 2, VEGF, Calbindin-D, Proteolipid protein RU Malendialdehyde, neuron-specific enolase gamma gamma isoform (NSE γ.γisoform), thrombus precursor protein, Chimerin, Fibrinopeptide A (FPA), plasmin-α 2AP complex (PAP), plasmin inhibitory complex (PIC), beta-thromboglobulin ( β̅TG), Prothrombin fragment 1+2, PGI2, Creatinine phosphokinase brain band, neurotrophin-3 (NT-3), neurotrophin-4/5 (NT-4/5), neurokinin A, neurokinin B, neurotensin, neuropeptide Y, Lactate dehydrogenase (LDH), soluble thrombomodulin (sTM), Insulin-like growth factor-1 (IGF-1), protein kinase C gamma (PKC-γ, Secretagogin, PGE2,8-epi PGF.sub.2alpha and Transforming growth factor βeta (TGF-β) or markers related thereto.

23. The method of claim 22
wherein the correlating is further so as to determine relative risk of a bleeding event upon treatment in a human subject who has suffered a myocardial infarction (MI); and
wherein the correlating is performed in accordance with an algorithm drawn from the group consisting essentially of: linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; recursive feature elimination or entropy-based recursive feature elimination algorithms; a plurality of algorithms arranged in a committee network; and forward floating search or backward floating search algorithms.

24. The method of claim 23 wherein the correlating so as to further determine the relative risk of a bleeding event is, in addition to determining relative risk of a bleeding event in patients who have suffered a MI, expanded to predict risk of a bleeding event in patients who are suffering from cardiovascular disease.

25. The method of claim 11 wherein the correlating of clinical patient information is of clinical patient information is selected from a group consisting of Complete blood count (CBC), Coagulation test, Blood chemistry (glucose, serum electrolytes {Na, Ca, K}), Leukocyte and Neutrophil counts, platelet count, and Blood lipids tests.

26. The method of claim 11 wherein the correlating of clinical patient information is of clinical patient information is selected from a group consisting of age, weight, height, body mass index, computed tomography scan information, Magnet Resonance Image scan information, gender, time from onset of stroke-like symptoms, time to recanalization, ethnicity, heart rate, blood pressure, respiration rate, blood oxygenation, previous personal and/or familial history of cardiac events, recent cranial trauma and unequal eye dilation.

27. The method of claim 11
wherein the obtaining of the test sample from the human subject is within a specific time window from onset of symptoms; and
wherein the correlating is between (1) non-marker and proteomic marker values, and (2) the probability of present or future risk of a bleeding event for the human subject for a selected treatment, within a recommended time window after onset of symptoms for said selected treatment.

28. The method of claim 27
wherein the correlating is in accordance with an algorithm drawn from the group consisting essentially of: linear or nonlinear regression algorithms; linear or nonlinear classification algorithms; ANOVA; neural network algorithms; genetic algorithms; support vector machines algorithms; hierarchical analysis or clustering algorithms; hierarchical algorithms using decision trees; kernel based machine algorithms such as kernel partial least squares algorithms, kernel matching pursuit algorithms, kernel fisher discriminate analysis algorithms, or kernel principal components analysis algorithms; Bayesian probability function algorithms; Markov Blanket algorithms; recursive feature elimination or entropy-based recursive feature elimination algorithms; a plurality of algorithms arranged in a committee network; and forward floating search or backward floating search algorithms.

29. A kit for determining presence, or predicting risk of, a bleeding event following therapy in a human subject who has suffered from a myocardial infarction (MI) comprising:
a device having reagents at each of a plurality of discrete locations, each reagent and corresponding location configured and arranged to immobilize for detection one of said plurality of subject-derived markers, supporting an analysis of both (1) cellular fibronectin and (2) additional markers; and
a computer algorithm, residing on a computer, calculating in consideration of blood plasma or serum levels of cellular fibronectin and additional markers a probability of present or future risk of a bleeding event for said subject.

29. A kit for determining presence, or predicting risk of, a bleeding event following therapy in a human subject who has suffered from a myocardial infarction (MI) comprising:
a device having a reagent at a discrete location, said reagent at said location configured and arranged to immobilize cellular fibronectin in blood of the human subject for detection and analysis of the amount of cellular fibronectin present in the blood.

30. The kit according to claim 29
wherein the device further has reagents at each of a plurality of discrete locations, each reagent and corresponding location configured and arranged to immobilize for detection one of a plurality of subject-derived markers, the combined reagents and locations supporting an analysis of both amounts of (1) cellular fibronectin and (2) additional markers;
and wherein the kit further comprises:
a computer algorithm, residing on a computer and calculating in consideration of the analyzed amounts of the cellular fibronectin and additional markers, deriving a probability of present or future risk of a bleeding event for said subject.
